(19) United States
(12) Patent Application Publication
(10) Pub. No.: US 2007/0048432 A1
(43) Pub. Date: Mar. 1, 2007

(54) Use of dextrin in animal feeds

(75) Inventors: David Paul Holzgraefe, Quincy, IL (US); John F. Less, Forsyth, IL (US); Thomas E. Shipp JR., Warsaw, NC (US); Hong Yang, Peoria, IL (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(73) Assignee: Archer-Daniels-Midland Company

(21) Appl. No.: 11/509,152

(22) Filed: Aug. 24, 2006

Related U.S. Application Data
(60) Provisional application No. 60/711,161, filed on Aug. 25, 2005.

(51) Int. Cl. A23G 3/00

(52) U.S. Cl. 426/658

(57) ABSTRACT

The present disclosure provides methods and compositions for increasing production in animals by feeding the animals a composition which includes a soluble dextrin product. The composition may be fed to the animal in the form of a complete feed, a concentrate, a pre-mix, and a top-dress and may be in either a liquid or solid formulation.

### CROSS REFERENCE TO RELATED APPLICATIONS

This application claims priority under 35 U.S.C. §119(e) to U.S. Provisional Application Ser. No. 60/711,161, filed Aug. 25, 2005, the disclosure of which is incorporated herein by reference in its entirety.

### TECHNICAL FIELD

The present disclosure relates generally to animal feeds, and more particularly to methods and compositions for increasing the production of animals by feeding the animals a composition comprising a soluble dextrin product. Other non-limiting embodiments comprise an animal feed composition comprising the soluble dextrin product.

### BACKGROUND

Starch is a naturally occurring polymer made up of anhydroglucose units and may be obtained by processing plant materials. The plant materials from which starch may be derived include, but are not limited to corn, wheat, potato, cassava, and rice. Of these plant materials, corn is one of the most commonly used sources for starch in North America.

Starch is used in a wide number of applications, both industrial and private. These uses include, but are not limited to, food ingredients, papermaking, corrugated boxes, glue, baby powder and textiles. Food ingredients produced from starch are varied and include, but are not limited to, dextrose, corn syrup, high fructose corn syrup, crystalline dextrose, fructose, xanthan gum, citric acid, lactic acid, sorbitol, lysine, threonine, riboflavin and distilled spirits.

An additional product is resistant starch, which is a name given to starches which are not substantially digested in the stomach or small intestine and pass substantially intact into the large intestine. Resistant starch is an important part of the human diet. Resistant starch has been shown to promote intestinal regularity, moderate post-prandial blood glucose levels, and lower serum cholesterol and triglyceride levels. Resistant starches may be categorized into four main groups: RS1, RS2, RS3, and RS4. RS1 starch is a physically inaccessible starch, such as, for example, starch trapped in seeds. RS2 starch is granular starch, such as, for example, high amylose starch and starch in bananas (e.g., banana peels). RS3 starch is a highly retrograded starch, such as, for example, starch from extruded cereals. RS4 starch is chemically modified starch.

One feature of these indigestible starches is that they are not substantially digested or absorbed by the upper gastrointestinal tract, including the small intestine, and reach the large intestine essentially intact. Upon reaching the large intestine, oligosaccharides, dietary fibers, and resistant starches are partly acted on by certain members of the genus Enterobacteriaceae yielding short-chain fatty acids, intestinal gases, vitamins, and the like. Acidification of the intestinal environment by the short-chain fatty acids may help improve gut health. It has also been reported that when these short chain fatty acids are metabolized, they may provide energy and inhibit the synthesis of cholesterol. Therefore, indigestible substances may be necessary in obtaining many desirable physiological effects.

Examples of water-soluble indigestible substances include guar gum, glucomannan, pectin and like natural gums, that have high viscosity and are difficult to ingest in high amounts.

Thus, a need exists for animal feeds containing a water soluble, indigestible substance that is economical to manufacture and has a suitable viscosity, yet imparts the desired physiological effects to the animals that consume the animal feeds.

### SUMMARY OF INVENTION

Certain embodiments of the present disclosure describe methods of feeding an animal feed composition to an animal. In various embodiments, the animal feed composition includes a resistant starch.

Starch often includes alpha (1→4) and alpha (1→6) glucosidic linkages. Some resistant starches may be prepared by heat-treating a starch at a high temperature, however, the mechanism of resistant starch development is complex. During the initial stages of dextrinization, acid-catalyzed hydrolysis occurs. This is be followed by a recombination of the fragments to form branched structures. Specifically, the dextrinization process may convert a portion of the normal alpha (1→4) glucosidic linkages to random 1,2-, 1,3-, and 1,4-alpha or beta glucosidic linkages (O. B. Wurzburg, in Modified Starches: Properties and Uses, CRC Press Inc., Boca Raton, TL (1986) pp 33-34). While mammals have digestive enzymes capable of hydrolyzing or breaking the alpha (1→4) glucosidic linkages of starch, they typically lack native enzymes capable of hydrolyzing or breaking 1,2-, 1,3-, and 1,4-alpha or beta glucosidic linkages

Dextrins are starch hydrolysis products such as those obtained in a dry roasting process using starch alone, or starch combined with trace levels of an acid catalyst. The starch hydrolysis products have good solubility in water, resulting in stable viscosities. Various non-limiting methods of producing soluble dextrins suitable for use in the present disclosure is set forth in U.S. Patent Application Publication Nos. 2004/0167325 and 2006/0073263, the disclosures of which are incorporated in their entirety by reference herein.

In one embodiment, a method of feeding an animal comprises: obtaining a soluble dextrin product; mixing the soluble dextrin product with at least one feed ingredient, thus producing an animal feed composition; and feeding the animal feed composition to the animal. The soluble dextrin product comprises 40% to 90% soluble fiber, has an average molecular weight of approximately 2500 atomic mass units (“amu”), and may include from 10% to 20% of oligosaccharides in the dextrin having from 2 to 10 degrees of polymerization.

Other non-limiting embodiments disclose an animal feed composition comprising at least one feed ingredient and a soluble dextrin having 40% to 90% soluble fiber. The animal feed composition may be fed to the animal in either dry or liquid form.

Another non-limiting embodiment discloses a method of distributing an animal feed. The method comprises admixing a soluble dextrin product with at least one feed ingredient selected from the group consisting of a mannanoligosaccharide product, a direct fed microbial product, a beta-glucan product, an amino acid, a sugar alcohol, a sugar, a milk product, a vitamin, a mineral, and combinations of any thereof, thus producing the animal feed composition; placing the animal feed composition in a container configured for shipping; and transporting the container to a location.

### DESCRIPTION OF DRAWINGS

The various non-limiting embodiments of the present disclosure may be better understood when read in conjunction with the following figures.

FIG. 1 illustrates body weight changes of pigs fed a diet comprising one embodiment of the animal feed compositions of the present disclosure.

FIG. 2 illustrates the quadratic and cubic effect on efficiency (feed:gain ratio) of pigs fed a diet comprising one embodiment of the animal feed compositions of the present disclosure.

FIG. 3 illustrates the effect on average daily gain, average daily feed intake and efficiency (feed:gain ratio) for pigs fed diets comprising certain embodiments of the animal feed compositions of the present disclosure, compared to a control diet.

FIG. 4 illustrates the final weight of finisher pigs fed diets comprising certain embodiments of the animal feed compositions of the present disclosure, compared to a control diet.

FIG. 5 illustrates changes in populations of beneficial and harmful bacteria in swine fed a diet comprising one embodiment of the animal feed compositions of the present disclosure, compared to a control diet.

### DETAILED DESCRIPTION

Other than in the operating examples, or where otherwise indicated, all numbers recited herein expressing quantities of ingredients, reaction conditions and the like are to be understood as being modified in all instances by the term “about”. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. Also, unless denoted otherwise, percentages of components in a composition are presented as weight percent.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure describes several different features and aspects of the invention with reference to various exemplary non-limiting embodiments. It is understood, however, that the invention embraces numerous alternative embodiments, which may be accomplished by combining any of the different features, aspects, and embodiments described herein in any combination that one of ordinary skill in the art would find useful.

The present disclosure discloses methods for increasing production in animals, such as, for example, livestock, poultry, pets, crustaceans, and fish. The methods generally comprise the use of a soluble dextrin in the diet of the animal. The method may be used to deliver nutrient substrates that enhance the presence of beneficial microbial populations in the digestive tracts of the animal. The referenced benefits influence livestock productivity through growth performance, feed efficiency, disease resistance, and/or lactation performance. Also disclosed herein are animal feed compositions comprising at least one feed ingredient and the soluble dextrin product. According to certain non-limiting embodiments, the soluble dextrin products of the present disclosure may comprise grain starch molecules that have been treated by any of the processes generally described in co-pending U.S. Patent Application Publication Nos. 2004/0167325 and 2006/0073263, the disclosures of which are incorporated in their entirety by reference herein.

For example, according to various non-limiting embodiments, the resistant starch dextrin product, for example a resistant dextrin product, may be prepared by the process comprising: selecting a reaction temperature, such as, for example, a temperature of 140° C. to 180° C.; acidifying an unmodified starch to a pH, such as, for example, a pH of 1 to 4, wherein the pH is optimum to convert the unmodified starch to a resistant starch, when at the reaction temperature; heating the acidified unmodified starch to the reaction temperature; and maintaining the acidified unmodified starch close to the reaction temperature until a maximum yield of resistant starch has been obtained, while maintaining an acceptable whiteness level, such as, for example a whiteness level of between 50 and 100. According to various non-limiting embodiments, the unmodified starch may be derived from any of corn, potatoes, rice, cassava, or wheat. According to certain non-limiting embodiments, the unmodified starch is an unmodified wheat starch.

Dextrin produced by the method above and/or any of the various methods disclosed in U.S. Patent Application Publication Nos. 2004/0167325 and/or 2006/0073263 may comprise starch molecules, wherein at least a portion of chemical bonds of the unmodified starch are altered, for example, where the normal alpha 1,4-glucose linkages of the starch molecules have been converted to random 1,2-, 1,3-, and 1,4-alpha and beta glycosidic linkages via the dextrinization process. The dextrin product is highly soluble in water or aqueous solutions, and has a solubility of over 70%. In certain non-limiting embodiments, the solubility of the dextrin product is greater than 90%. In addition, the soluble dextrin contains 40% to 90% soluble fiber and has a Dextrose Equivalent of from 1 to 20. As described above, the altered chemical bonds are substantially resistant to digestion in the upper digestive tract of mammals.

The molecular formula of the soluble dextrin of the various non-limiting embodiments of the present disclosure may have an average molecular weight of approximately 2500 amu. According to certain non-limiting embodiments, the soluble dextrin may have an average molecular weight of 2000 amu to 3000 amu. The soluble dextrin may include oligosaccharides of varying polymer chain length, with 10% to 20% of the oligosaccharides of the soluble dextrin product having a degree of polymerization of 2 to 10 degrees. As used herein the term “degree of polymerization” means the number of individual glucose monomer saccharide units bonded together to form the oligosaccharide. For example, a dextrin having 5 degrees of polymerization consists of an oligomer of 5 glucose monomer saccharide units.

Dextrin has been classified as generally recognized as safe (GRAS) by the United States Food and Drug Administration for consumption by humans (see, 21 C.F.R. 184.1277).

In general, enzymes in the digestive system of mammals is only able to digest oligo- and polysaccharides having alpha-1,4-glycosidic linkages. Therefore, the other linkages created by the dextrinization process of the various non-limiting embodiments of the present disclosure, as described herein, may be substantially resistant to digestion within the small intestine of the animal and pass substantially intact into the large intestine of the animal. As used herein in the context of digestion of resistant starch, the term “substantially” includes greater than 70%.

The large intestine of mammals generally contains microbial flora that aid in the digestion of food. The microbial flora may be classified into either beneficial microbes and/or bacteria or harmful microbes and/or bacteria. It is generally believed that beneficial microbes/bacteria, such as, for example, Lactobacillus and Bifidobacteria, within the intestinal tract provide for increased health and production through a variety of means, including improved immune function. On the other hand, harmful bacterial populations, such as, for example, Escherichia coli (“E. coli”), Salmonella, Clostridia perfringens, Proteus, and Klebsiella, within the intestinal tract may lead to decreased health and increased incidence of disease.

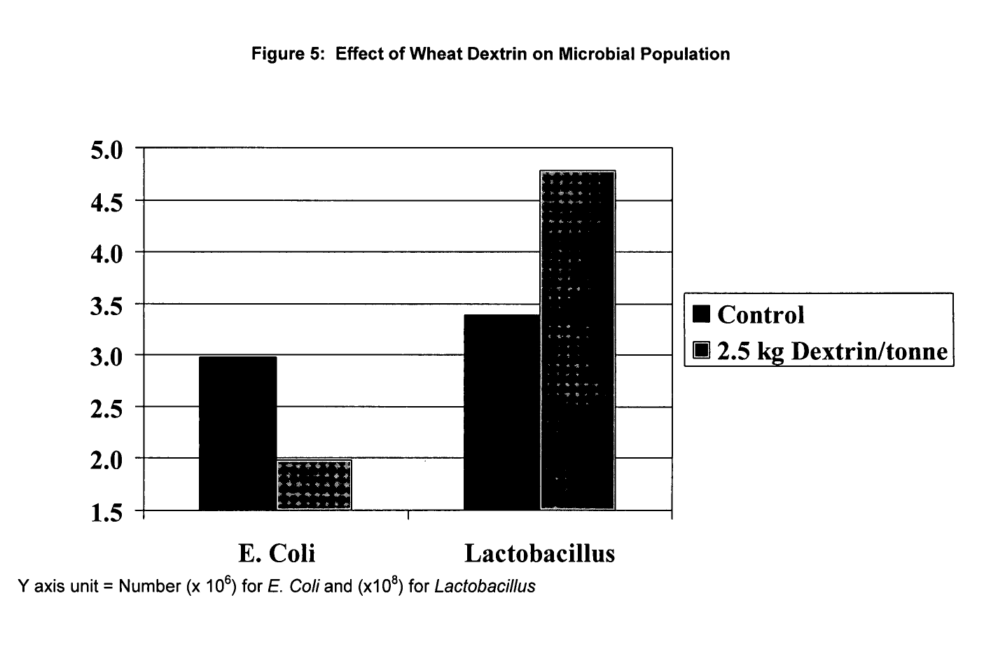

Digestion resistant soluble dextrin of the non-limiting embodiments of the present disclosure are prebiotic and are passed through the upper digestive tract of the animals and pass substantially intact into the large intestine, where the soluble dextrin may serve as nutrients for the microbes therein. Animals, such as, for example, livestock; including swine, fed the soluble dextrin products according to the various embodiments disclosed herein, at low dietary levels, show improved growth performance, promoted hindgut growth of healthy bacteria, such as, for example, Lactobacillus and Bifidobacteria or combinations thereof, and decreased growth of harmful bacteria, such as, for example, E. coli, Salmonella, and Clostridium or combinations of any of these harmful bacteria, as compared to animals fed a comparable diet that does not include the soluble dextrin product. For example, FIG. 5 illustrates the change in the large intestine microbial population for Lactobacillus and E. coli achieved upon feeding swine a diet including the soluble dextrin product according to certain embodiments disclosed herein, such as, the animal feed composition described in Example 5. Other harmful bacteria that may be inhibited by consumption of the animal feed compositions of the present disclosure include, for example, Salmonella, Clostridia perfringens, Proteus, and Klebsiella or combinations of any thereof. This prebiotic effect is expected to be observed in other mammals, such as, other livestock including, but not limited to, bovines, ovines, caprines, and equines; other commercially raised animals such as mink, llama, and alpaca; poultry and fowl, such as chickens, turkeys, geese, pheasants, and ducks; ratites, such as emus and ostrich; pets, such as canines and felines; fish; and crustaceans.

The soluble dextrin product may be included in the animal diets in the form of a complete feed, a concentrate that is added to a feed product, a pre-mix that may be mixed with a feed product, and as a top-dress. As used herein, the term “top-dress” includes when the soluble dextrin product is applied or spread on to the top of a feed composition. The present disclosure discloses animal feed compositions comprising at least one feed ingredient and the soluble dextrin product. As will be recognized by one of ordinary skill in the art, the levels of inclusion of the soluble dextrin product relative to the at least one feed ingredient in the various formulations may vary. For example, in various non-limiting embodiments where the soluble dextrin product is fed to the animal in the form of a complete feed, the soluble dextrin product may comprise from 0.1% to 2.0% by weight of the complete feed product.

According to other non-limiting embodiments where the soluble dextrin product is fed to the animal in the form of a concentrate, the soluble dextrin product may comprise from 0.28% by weight to 10% by weight of the concentrate. The concentrate may be used in the final complete feed at from 10% by weight to 35% by weight of the final complete feed composition.

In other non-limiting embodiments where the soluble dextrin product is in the form of a pre-mix, the soluble dextrin product may comprise from 2% by weight to 50% by weight of the pre-mix, wherein the pre-mix may be added to the feed product in an amount comprising 2% by weight to 5% by weight of the final complete feed.

In other non-limiting embodiments where the soluble dextrin product is in the form of a top-dress, the amount of soluble dextrin product added to the feed may vary depending on how much of the top-dress is fed to the animals on a daily basis. To calculate the concentrations of the soluble dextrin product in the top-dress products, the soluble dextrin should be top-dressed on an animal feed composition or product in an amount that is equivalent to soluble dextrin concentrations of 0.1% to 2.0%, by weight, as recommended for the complete feeds.

In addition to feeding the animal the soluble dextrin product as part of a complete feed composition, such as, for example, as a feed product, a concentrate, a pre-mix, or a top-dress, the soluble dextrin product may also be fed to the animal as a feed composition in conjunction with at least one other product, such as, for example, a mannanoligosaccharide product; fructooligosaccharide products, a sugar alcohol, such as, for example sorbitol; a beta-glucan product; a medicament, such as an antibiotic; and/or a product, including, but not limited to, microorganism cell walls and/or its extract, of a fermentation reaction, such as a yeast biomass, a lysine biomass, an ethanol fermentation biomass, or a citric acid fermentation biomass. In other embodiments, one or more plant botanical or plant extract may be used or combined into the animal feed compositions.

Mannanoligosaccharide products, fructooligosaccharide products, and beta-glucan products comprise oligosaccharides that may be isolated, for example, from yeast, yeast products, bacterial or algae cultures, and yeast cultures. Oligosaccharides suitable for use in combination with the soluble dextrin product according to certain non-limiting embodiments of the present disclosure may include, but are not limited to, yeast, including yeast dried on a suitable carbohydrate carrier; yeast cultures; algae cultures; bacterial cultures; modified starches; enzymes extracted or isolated from a bacteria, yeast or mold; yeast extracts; modified yeast extracts; spray dried yeast culture, a spray dried bacterial culture; and other oligosaccharides.

As used herein, the term “yeast culture” is defined as the product comprising mycelium of yeast fermentation and the media on which it was grown, such as, for example, a presscake. The yeast culture comprises the enzyme system of the viable organism and its concomitant metabolites produced during the fermentation process and not removed during the separation process. The process of separation includes, but is not limited to, filtration and pressing, and centrifugation. The fermentation process can be, but is not limited to, a penicillium fermentation, a Streptomyces fermentation, an ethanol fermentation, or a citric acid fermentation. Yeast organisms useful in the compositions described herein include, without limitation, the Saccharomyces, Candida, Pichia, Yarrowia, Kluyveromyces, or Torulaspora species. In certain non-limiting embodiments of the present disclosure, the yeast used is Pichia guilliermondii or Yarrowia lipolytica.

As used herein, the term “presscake” includes the filtered or centrifuged; and dried mycelium obtained from separation of the fermentation. The term “citric acid presscake”, as used herein, includes the filtered or centrifuged; and dried mycelium obtained from a citric acid fermentation using an acceptable aqueous carbohydrate substrate. The term “ethanol presscake” includes the filtered or centrifuged mycelium obtained from an ethanol fermentation using an acceptable aqueous carbohydrate substrate. The yeast organism may be made nonviable and may be completely removed from the citric acid or ethanol during the separation and purification process. Citric acid presscakes can be a product resulting from Pichia or Yarrowia yeast fermentation to produce citric acid, in which case it contains cell walls and cell wall contents with high concentrations of mannanoligosaccharides, fructooligosaccharides, and/or beta-glucans. The oligosaccharides and yeast cultures that may be used in the compositions of the present disclosure may be obtained, for example, from a variety of commercial sources. Non-limiting examples of commercially available oligosaccharide sources, yeasts, yeast products, presscakes, and yeast cultures and extracts suitable for use in the compositions of the present disclosure include, but are not limited to, CitriStim (Pichia guilliermondii, citric acid fermentation cultures product from Archer Daniels Midland, of Decatur, Ill.), Nutrasound (Lactobacilli fermentation product available from ADM Alliance Nutrition, Inc. of Quincy, Ill.), Prosponse (Saccharomyces cerevisiae brewer's yeast, available from ADM Alliance Nutrition, Inc. of Quincy, Ill.), A-max (S. cerevisiae brewer's yeast culture available from Vi-cor of Mason City, Iowa), YeaSacc (S. cerevisiae yeast culture available from Alltech of Lexington, Ky.), BioSaf and Procreatin (S. cerevisiae yeast available from LaSaffre Yeast Corp. of Milwaukee, Wis.), Levucell S C (S. cerevisiae yeast available from Lallemand, Inc. of Chicago, Ill.), and Diamond V yeast culture (S. cerevisiae yeast culture available from Diamond V of Cedar Rapids, Iowa).

In other non-limiting embodiments, a feed product composition comprising the soluble dextrin product and at least one other product, such as a mannanoligosaccharide product, may produce a synergistic effect to the immune function of the animal, which may result in improved animal performance. According to one non-limiting embodiment, animal immune function may be improved when the animals are fed a diet comprising the soluble dextrin and a mannanoligosaccharide product. The improved immune function may be more than the sum of the improvements in immune function observed from diets comprising either the soluble dextrin or the mannanoligosaccharide product. Therefore, according to certain non-limiting embodiments, the soluble dextrin product may be mixed with a mannanoligosaccharide product prior to feeding to the animal.

In another non-limiting embodiment, the feed product composition may comprise the soluble dextrin product and a side product from a fermentation reaction, such as, for example, a beta-glucan or a fermentation biomass. According to various non-limiting embodiments, the soluble dextrin product may also be mixed with a beta-glucan product prior to feeding the composition to the animal.

The dextrin products of the various non-limiting embodiments of the present disclosure may also be fed to a variety of animals where improved production and performance is desirable, such as, for example, improved growth performance, improved feed efficiency (which may be measured by the ratio of weight of feed consumed to body weight gained), disease resistance, general health, lactation performance, any combination thereof.

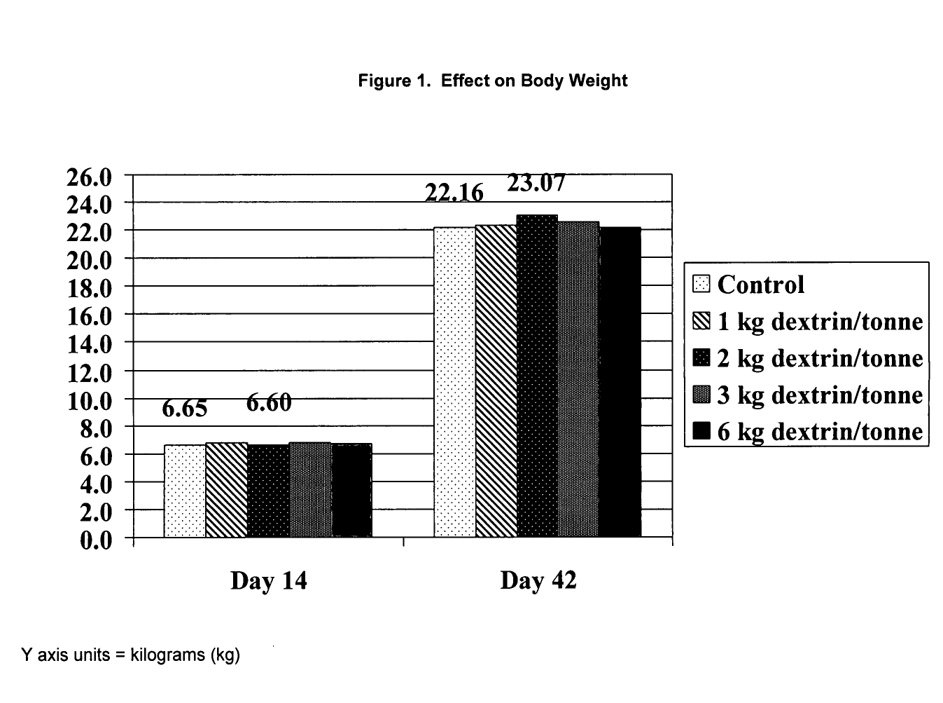

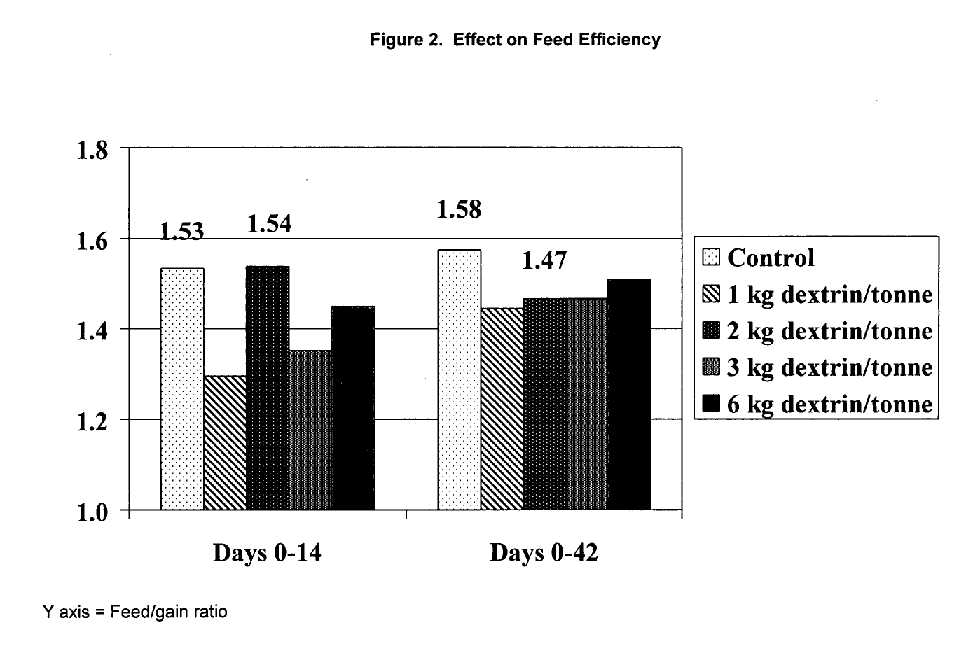

For example, in a study with nursery swine, a medicated diet including a soluble wheat dextrin product according to one non-limiting embodiment of the present disclosure (see, Example 4) increased nursery exit weight up to 0.91 kg (2 lb) for swine fed 2 kg of the soluble dextrin per tonne of feed (4 lb of the soluble dextrin per ton of feed), compared to nursery swine fed a control diet (see, FIG. 1, showing body weight gain in kg (lbs) for each diet). The diet containing the soluble dextrin also displayed a quadratic and cubic effect on feed efficiency (see, FIG. 2). In certain embodiments, the soluble dextrin may be included in a diet, as part of a complete feed, in quantities from 1 kg to 6 kg soluble dextrin per tonne of complete feed (2 lbs to 12 lbs soluble dextrin per ton of complete feed). According to other non-limiting embodiments, the soluble dextrin may be included in a diet, as part of a complete feed, in quantities from 1 kg to 3 kg soluble dextrin per tonne of complete feed (2 lbs to 6 lbs soluble dextrin per ton of complete feed). According to still other non-limiting embodiments, the soluble dextrin may be included in a diet in quantities from 1 kg to 2 kg soluble dextrin per tonne of complete feed (2 lbs to 4 lbs soluble dextrin per ton of complete feed).

In other embodiments, the soluble dextrin product may be included in a diet as part of a complete feed, in quantities of 1 kg to 6 kg soluble dextrin per tonne of complete feed (2 lbs to 12 lbs of soluble dextrin product per ton of complete feed). According to other non-limiting embodiments, the soluble dextrin product may be included in a diet as part of a complete feed, in quantities of 1 kg to 3 kg soluble dextrin per tonne of complete feed (2 lbs to 6 lbs of soluble dextrin product per ton of complete feed). According to still other non-limiting embodiments, the soluble dextrin product may be included in a diet as part of a complete feed, in quantities of 1 kg to 2 kg soluble dextrin per tonne of complete feed (2 lbs to 4 lbs of soluble dextrin product per ton of complete feed).

In additional non-limiting embodiments, the methods of the present disclosure enable the reduction of antibiotic use in animal feeding programs. Antibiotics, such as, for example, Mecadox® (available from Phibro Animal Health, Ridgefield Park, N.J., Mecadox® is a trademarked brand name for the antibiotic carbadox, registered to Pfizer Inc., New York, N.Y.) and Tylan® (available from Elanco Animal Health of Greenfield, Ind., Tylan® is a trademarked brand name for the antibiotic tylosin phosphate, registered to Eli Lilly and Co., Corp., Indianapolis, Ind.), may be incorporated into animal diets to increase production and growth performance, such as, for example, weight gain and feed efficiency, and/or to control enteric diseases. By using a diet comprising at least one animal feed and the soluble dextrin product, according to the various non-limiting embodiments described herein, and increasing gut healthy bacteria, such as, for example, Lactobacillus and Bifidobacteria or combinations thereof, and decreasing harmful bacteria, such as, for example, E. coli, Salmonella, and Clostridium or combinations of any thereof, increased animal production and growth performance may be observed in diets with reduced quantities of added antibiotics or without added antibiotics altogether.

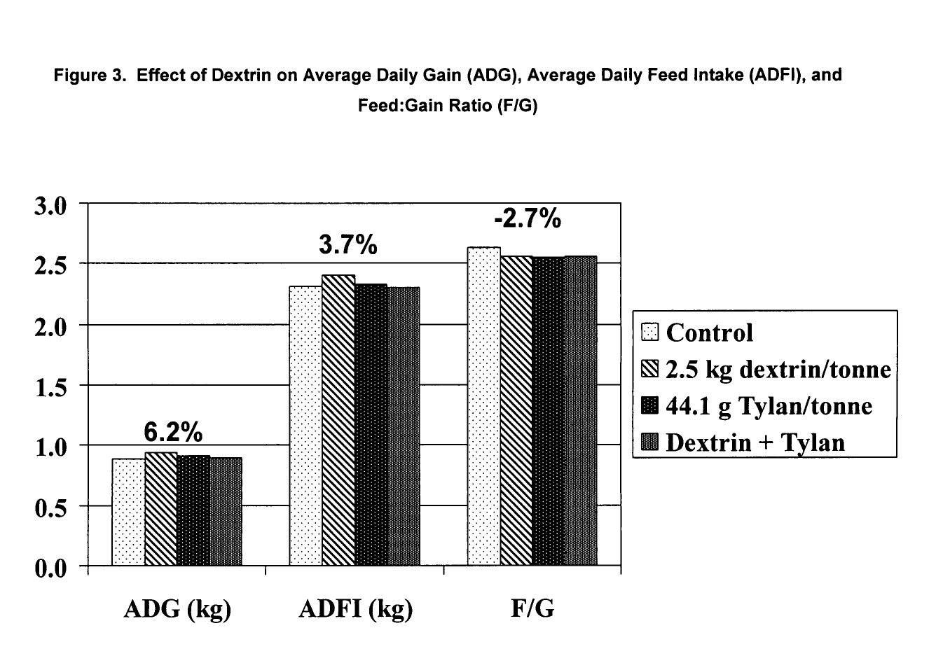

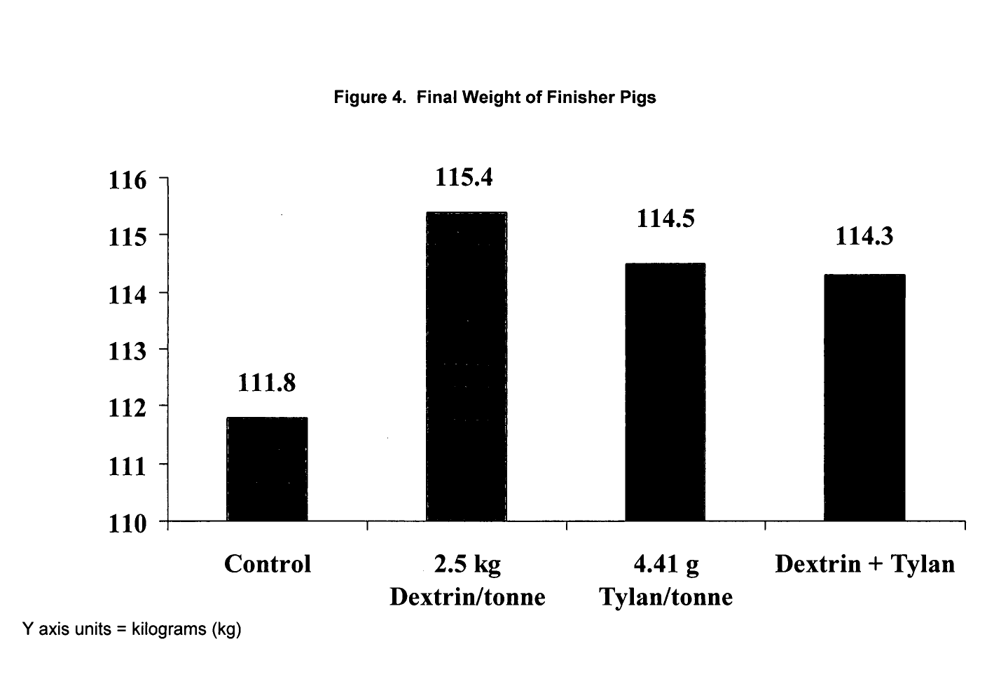

In one embodiment (see, Example 5), swine fed a diet comprising 2.5 kg of soluble dextrin per tonne of feed (5 lb of soluble dextrin per ton of feed) showed improved performance over swine fed a diet containing the antibiotic Tylan® at 44.1 g of antibiotic per tonne of feed (40 g of antibiotic per ton of feed); swine fed a diet containing both the soluble dextrin at 2.5 kg of soluble dextrin per tonne of feed (5 lb of soluble dextrin per ton of feed) and Tylan® at 44.1 g of antibiotic per tonne of feed (40 g of antibiotic per ton of feed), respectively; and a control diet containing neither the soluble dextrin product nor antibiotic (see, FIG. 3). For example, grower/finisher pigs fed the diet containing the soluble dextrin showed increased average daily gain, increased average daily feed intake, and improved feed efficiency (feed:gain ratio) as compared to grower/finisher pigs fed the control diet. In addition, the pigs fed the diet containing the soluble dextrin had a final weight of up to 3.72 kg (8.1 lbs) heavier than swine fed the control diet and 0.95 kg (2.1 lbs) heavier than swine fed the diet containing Tylan® (see, FIG. 4).

The present disclosure also includes an animal feed composition comprising at least one feed ingredient; and the soluble dextrin having 40 to 90% soluble fiber. According to certain non-limiting embodiments, the soluble dextrin has a dextrose equivalent of 1 to 20 and/or an average molecular weight of approximately 2500 amu. According to certain non-limiting embodiments, the soluble dextrin may have an average molecular weight of 2000 amu to 3000 amu. The soluble dextrin may include 15% of oligosaccharides having a degree of polymerization of 2 to 10. In certain embodiments, the animal feed composition may comprise the soluble dextrin at 0.1% to 2.0% by weight of the animal feed composition. The animal feed composition may be configured in either a liquid form or a dry form.

The animal feed composition, according to any of the various non-limiting embodiments, is capable of increasing the population of beneficial bacterial, such as at least one of Lactobaccilus and Bifidobacteria, in the gastrointestinal tract, such as, for example, the latter portions of the gastrointestinal tract (i.e., the large intestine) of an animal upon feeding the animal feed composition comprising the soluble dextrin to the animal. According to other non-limiting embodiments, the animal feed composition comprising the soluble dextrin is capable of decreasing the growth of E. coli, Salmonella, Clostridium and/or other harmful bacteria of combination of bacteria in the gastrointestinal tract, such as, for example, in the latter portions of the gastrointestinal tract (i.e., the large intestine) of an animal upon feeding the animal feed composition comprising the soluble dextrin to the animal.

The animal feed composition, according to various non-limiting embodiments, may be capable of reducing concentrations of odor-related compounds, such as, for example, indoles and phenols, in the waste product of animals fed the animal feed composition. As a result, the animal feed comprising the soluble dextrin may reduce odor emission of the animal waste, such as, for example, the odor of waste ponds on large animal farms or feed lots, and/or the offensiveness of animal manures to humans and animals. Thus, the animal feed composition comprising the soluble dextrin may be more environmentally friendly.

According to certain non-limiting embodiments, at least one feed ingredient may be a mannanoligosaccharide product, a direct fed microbial product, a beta-glucan product, an amino acid (for example, any of the essential amino acids, such as, lysine, methionine, threonine or combinations thereof), a sugar alcohol, a sugar, a milk product, a vitamin, a mineral, and/or any combinations thereof.

According to other non-limiting embodiments, the animal feed composition may further comprise at least one other product, such as, for example, a mannanoligosaccharide product; a sugar alcohol, such as, for example sorbitol; a beta-glucan product; a medicament, such as an antibiotic; and/or a side product of a fermentation reaction, such as a yeast biomass, a lysine biomass, ethanol fermentation biomass, or a citric acid fermentation biomass.

The present disclosure also includes various processes for raising an animal. The process may comprise feeding an animal feed composition comprising the soluble dextrin, according to any of the various non-limiting embodiments described herein, to the animal.

In other non-limiting embodiments, the present disclosure includes a method of feeding an animal comprising obtaining a soluble dextrin product as described herein, mixing the soluble dextrin product with at least one feed ingredient, thus producing an animal feed composition, such as any of the various embodiments of the animal feed composition described herein; and feeding the animal composition to the animal. The animal feed composition may be in a dry or liquid form and the soluble dextrin product may comprise 0.1% to 2.0% by weight of the animal feed composition. The soluble dextrin product may be in the form of a concentrate, a pre-mix, and a top-dress. According to certain non-limiting embodiments, the method may further comprise mixing a second feed ingredient with the soluble dextrin product. The second feed ingredient may be a mannanoligosaccharide product, a direct fed microbial product, a beta-glucan product, an amino acid, a sugar alcohol, a sugar, a milk product, a vitamin, a mineral, and any combinations thereof.

As described herein, according to certain non-limiting embodiments, a substantial portion of the soluble dextrin product of the animal feed composition may pass through the upper gastrointestinal tract of the animal and pass substantially intact into the large intestine of the animal. When the soluble dextrin product reaches the large intestine substantially intact, it may then serve as a food source for beneficial bacteria in the large intestine. In certain non-limiting embodiments, the population of harmful bacterial in the digestive tract of the animal may be decreased.

According to other non-limiting embodiments, the present disclosure also includes a method of distributing an animal feed composition, wherein the animal feed composition is made according to any of the various non-limiting embodiments disclosed herein, such as by admixing a soluble dextrin product with at least one feed ingredient; the method further comprising placing the animal feed composition in a container, such as for example, a bag, box, bottle, tank, or other suitable container, wherein the container is configured for shipping; and transporting the container, such as in a truck, train, boat, or airplane, to a location having animals. According to certain embodiments, the method may further comprise associating indicia with the container. The indicia may be configured to direct a user of the animal feed composition on how to mix the animal feed composition with another feed ingredient, how to feed the animal feed composition to the animals, or a combination thereof. The method may further comprise the step of feeding the animal feed composition to an animal, as described herein.

Animals for which the dextrins of the present disclosure may be a beneficial dietary supplement or component include livestock, such as, for example, bovines, ovines, swine, goats, and equines; other commercially raised animals, such as mink, llama, and alpaca; poultry and fowl, such as, for example, chickens, turkeys, geese, pheasants, and ducks; ratites, such as emus and ostrich; pets, such as for example, canines, and felines; fish, such as trout, salmon and farm raised fish; and crustaceans, such as shrimp, lobster, crayfish, prawns, and crabs. It is also contemplated that a diet comprising the soluble dextrin as described herein may also display beneficial effects in other mammals, such as, for example, humans. Thus, other embodiments may include the feeding of food compositions comprising the soluble dextrin to humans.

Various non-limiting examples of animal feed compositions comprising the soluble dextrin product and data showing the use of animal feed compositions comprising the soluble dextrin will now be disclosed. The following examples illustrate various non-limiting embodiments of the compositions within the present disclosure and are not restrictive of the invention as otherwise described or claimed herein.

### EXAMPLES

### Example 1

### Complete Feeds

In this Example, four samples of complete feed compositions comprising a wheat dextrin product according to the present disclosure are described. The four complete feed compositions are suitable for use as a nursery feed composition for nursery swine. The complete feed compositions were made by a conventional manufacturing process that is typically used in the feed industry to produce pellet or meal complete feeds. The compositions of the four complete feeds are listed in Table 1. All ingredient amounts were measured in weight percent of total feed composition.

TABLE 1
Complete Feed Compositions for Nursery Swine

| Ingredients (weight %) | Feed I | Feed II | Feed III | Feed IV |
|---|---|---|---|---|
| Grain Products | 25.36 | 32.93 | 48.46 | 54.66 |
| Plant Protein | 20.30 | 25.00 | 29.72 | 31.17 |
| Animal Protein | | 24.31 | 11.12 | 4.68 |
| Grain By-Products | 5.00 | 10.00 | 2.00 | 2.00 |
| Fat | 2.60 | 3.38 | 2.61 | 3.79 |
| Others | 7.46 | 4.08 | 5.79 | 3.39 |
| Wheat Dextrin | 0.30 | 0.30 | 0.30 | 0.30 |
| Total | 100.00 | 100.00 | 100.00 | 100.00 |
| Protein, % | 24.76 | 23.58 | 21.98 | 20.97 |
| Fat; Crude, % | 5.61 | 6.74 | 5.24 | 6.24 |
| Dry Matter, % | 90.74 | 89.96 | 88.81 | 88.00 |
| Moisture, % | 9.26 | 10.04 | 11.19 | 12.00 |
| Calcium, % | 0.98 | 1.00 | 0.90 | 0.90 |
| Phosphorus, % | 0.85 | 0.75 | 0.70 | 0.70 |
| Lysine, % | 1.91 | 1.59 | 1.39 | 1.30 |

### Example 2

### Concentrates

In this Example, four animal feed concentrates comprising a soluble dextrin product of the present disclosure are presented. The concentrates may be added to a feed product to produce a final feed formulation. The four concentrates are configured for use in swine feed compositions. The concentrates were made by using a conventional manufacturing process that is typically used in the feed industry to produce concentrates. The compositions of the four concentrates are listed in Table 2. All ingredient amounts were measured in weight percent of total concentrate composition.

The concentrates were mixed with other feed ingredients, such as, for example, corn, to make a complete feed composition using a conventional manufacturing process that is typically used in the feed industry to produce pellet or meal feed mixed with a concentrate.

TABLE 2
Compositions for Swine Concentrates

| Ingredients (weight %) | Conc. I | Conc. II | Conc. III | Conc. IV |
|---|---|---|---|---|
| Plant Protein | 72.11 | 21.90 | 75.82 | 62.64 |
| Grain By-Products | 2.65 | 17.50 | 2.00 | 11.55 |
| Animal Protein | 10.17 | 45.12 | 11.60 | 15.00 |
| Fat | 3.95 | 3.80 | — | 0.70 |
| Others | 10.59 | 11.00 | 9.58 | 8.68 |
| Wheat Dextrin | 0.53 | 0.68 | 1.00 | 1.43 |
| Total | 100.00 | 100.00 | 100.00 | 100.00 |
| Protein, % | 39.45 | 25.70 | 41.89 | 38.34 |
| Fat; Crude, % | 5.29 | 6.52 | 1.91 | 3.14 |
| Dry Matter, % | 91.16 | 92.99 | 90.91 | 91.66 |
| Moisture, % | 8.84 | 7.01 | 9.09 | 8.34 |
| Calcium, % | 2.22 | 2.61 | 3.61 | 3.21 |
| Phosphorus, % | 1.65 | 1.70 | 1.65 | 1.86 |
| Lysine, % | 3.10 | 2.00 | 2.65 | 2.85 |

By using an animal feed composition comprising the soluble dextrin at a concentration that is higher than the concentration that the soluble dextrin will actually be fed to an animal, a supplier, for example, a feed supplier or concentrate manufacturer, is enabled to ship or transport the concentrated animal feed composition at a reduced cost as compared to the shipping cost of a animal feed composition having a lower concentration of soluble dextrin, such as, an amount equal to the recommended dietary levels of dextrin. After arriving at the destination, the animal feed composition comprising the concentrated soluble dextrin may be admixed with at least one other animal feed ingredient to produce a final feed composition having a recommended concentration of soluble dextrin.

Depending on the concentration of the soluble dextrin in the animal feed composition, a container for shipping or transporting the animal feed composition comprising the concentrated soluble dextrin may be associated with indicia configured to direct a user of the animal feed composition on how to admix the animal feed composition comprising the concentrated soluble dextrin with at least one other animal feed ingredient and/or how to feed the animal feed composition comprising the concentrated soluble dextrin to an animal.

### Example 3

### Pre-mixes

In this Example, four pre-mix compositions comprising a wheat dextrin product according to the present disclosure are described. The pre-mix compositions may be added to a feed product, such as, for example, by mixing into the feed product prior to feeding. The four pre-mix compositions are configured for mixing with swine feed products. The pre-mix compositions were made using a conventional manufacturing process that is typically used in the feed industry to produce pre-mixes. The compositions of the four pre-mix compositions are listed in Table 3. All ingredient amounts were measured in weight percent of total pre-mix.

TABLE 3
Compositions for Swine Pre-mixes

| Ingredients | | | | |
|---|---|---|---|---|
| (weight %) | Pre-mix I | Pre-mix II | Pre-mix III | Pre-mix IV |
| Grain By-Products | — | — | 15.00 | 9.65 |
| Animal Protein | — | — | 4.00 | 18.55 |
| Plant Protein | — | — | 3.55 | 9.20 |
| Minerals | 87.28 | 82.92 | 58.93 | 52.60 |
| Vitamins | 1.10 | 1.67 | 0.99 | 1.68 |
| Trace Minerals | 2.62 | 2.63 | 5.43 | 2.75 |
| Fat | 1.00 | 1.00 | 1.30 | — |
| Others | — | 5.08 | 6.80 | 0.27 |
| Wheat Dextrin | 8.00 | 6.70 | 4.00 | 5.30 |
| Total | 100.00 | 100.00 | 100.00 | 100.00 |
| Protein, % | .01 | 4.80 | 10.21 | 17.02 |
| Fat; Crude, % | .02 | .02 | 2.03 | 2.19 |
| Dry Matter, % | 98.76 | 98.80 | 97.47 | 96.28 |
| Moisture, % | 1.24 | 1.20 | 2.53 | 3.72 |
| Calcium, % | 23.49 | 20.12 | 13.89 | 14.53 |
| Phosphorus, % | 7.02 | 7.99 | 5.99 | 3.86 |
| Lysine, % | — | 4.00 | 2.60 | .90 |

The pre-mixes were mixed with other feed ingredients, such as corn meal and/or soybean meal to make a complete feed composition using a conventional manufacturing process that is typically used in the feed industry to add pre-mixes to feed ingredients.

By using a pre-mix comprising the soluble dextrin at a concentration that is higher than the concentration that the soluble dextrin will actually be fed to an animal, a supplier, for example, a feed supplier or pre-mix manufacturer is enabled to ship or transport the pre-mix composition at a reduced cost as compared to the shipping cost of a pre-mix composition having a lower concentration of soluble dextrin, such as, an amount equal to the recommended dietary levels of dextrin. After arriving at the destination, the pre-mix composition comprising the concentrated soluble dextrin may be admixed with at least one other animal feed ingredient to produce a final feed composition having a recommended concentration of soluble dextrin.

Depending on the concentration of the soluble dextrin in the pre-mix composition, a container for shipping or transporting the pre-mix composition comprising the concentrated soluble dextrin may be associated with indicia configured to direct a user of the pre-mix composition on how to admix the pre-mix composition comprising the concentrated soluble dextrin with at least one other animal feed ingredient and/or how to feed the pre-mix composition comprising the concentrated soluble dextrin to an animal.

### Example 4

### Dextrin in Medicated Nursery Diets

In this Example, the effect of the inclusion of the soluble dextrin in a diet containing the antibiotic carbadox was examined. The effect on average daily weight gain, overall body weight gain, average daily feed intake, and feed efficiency was determined.

A total of 150 pigs (average initial weight 4.15 kg/pig) were used to determine the effect of various inclusion levels of a soluble wheat dextrin product in medicated nursery swine diets. Pigs were divided into blocks by initial weight and given one of five dietary treatments. There were six pens per treatment and five pigs per pen. The five dietary treatments included: 0, 1, 2, 3 and 6 kg of soluble wheat dextrin per tonne of final complete diets of animal feed (0, 2, 4, 6 and 12 lbs of soluble wheat dextrin per ton of final complete diets of animal feed). The soluble dextrin was included in the animal feed formulation in place of an equal amount of corn in the complete animal feed. Carbadox at 55.1 g/tonne feed (50 g/ton feed) was used throughout the trial. The trial included four stages of 7, 7, 14, and 14 days, respectively. Diets including the soluble dextrin were offered in pellet form in stages 1 and 2, and in meal form in stages 3 and 4. Diet compositions for each treatment and phase are listed in Tables 4-7. The results from this Example are listed in Table 8.

TABLE 4
Composition of Stage 1 Diets

| | Treatment | | | | |
|---|---|---|---|---|---|
| | 1 | 2 | 3 | 4 | 5 |
| Ingredients, weight % | | | | | |
| Grain Products | 28.35 | 28.25 | 28.15 | 28.05 | 27.75 |
| Plant Protein | 17.93 | 17.93 | 17.93 | 17.93 | 17.93 |
| Animal Protein | 38.80 | 38.80 | 38.80 | 38.80 | 38.80 |
| Grain By-Products | 5.00 | 5.00 | 5.00 | 5.00 | 5.00 |
| Fat | 2.00 | 2.00 | 2.00 | 2.00 | 2.00 |
| Others | 7.68 | 7.68 | 7.68 | 7.68 | 7.68 |
| Wheat Dextrin | — | 0.10 | 0.20 | 0.30 | 0.60 |
| Microingredients | 0.24 | 0.24 | 0.24 | 0.24 | 0.24 |
| Total | 100.00 | 100.00 | 100.00 | 100.00 | 100.00 |
| Calculated Nutrient | | | | | |
| Analysis | | | | | |
| Protein, % | 24.53 | 24.52 | 24.51 | 24.51 | 24.48 |
| Fat; Crude, % | 5.14 | 5.13 | 5.13 | 5.12 | 5.11 |
| Fiber, % | 1.52 | 1.52 | 1.52 | 1.52 | 1.51 |
| Dry Matter, % | 90.66 | 90.68 | 90.69 | 90.71 | 90.74 |
| Moisture, % | 9.34 | 9.32 | 9.31 | 9.29 | 9.26 |
| Calcium, % | 1.00 | 1.00 | 1.00 | 1.00 | 1.00 |
| Phosphorus, % | 0.86 | 0.86 | 0.86 | 0.86 | 0.86 |
| Lysine, % | 1.90 | 1.90 | 1.90 | 1.90 | 1.90 |

TABLE 5
Composition of Stage 2 Diets

| | Treatment | | | | |
|---|---|---|---|---|---|
| | 1 | 2 | 3 | 4 | 5 |
| Ingredients, weight % | | | | | |
| Grain Products | 34.12 | 34.02 | 33.92 | 33.82 | 33.52 |
| Plant Protein | 21.20 | 21.20 | 21.20 | 21.20 | 21.20 |
| Animal Protein | 21.61 | 21.61 | 21.61 | 21.61 | 21.61 |
| Grain By-Products | 13.00 | 13.00 | 13.00 | 13.00 | 13.00 |
| Fat | 3.54 | 3.54 | 3.54 | 3.54 | 3.54 |
| Others | 6.53 | 6.53 | 6.53 | 6.53 | 6.53 |
| Wheat Dextrin | — | 0.10 | 0.20 | 0.30 | 0.60 |
| Total | 100.00 | 100.00 | 100.00 | 100.00 | 100.00 |
| Calculated Nutrient | | | | | |
| Analysis | | | | | |
| Protein, % | 22.55 | 22.54 | 22.54 | 22.53 | 22.51 |
| Fat; Crude, % | 6.75 | 6.75 | 6.75 | 6.74 | 6.73 |
| Fiber, % | 2.22 | 2.22 | 2.21 | 2.21 | 2.20 |
| Dry Matter, % | 90.31 | 90.32 | 90.33 | 90.35 | 90.39 |
| Moisture, % | 9.69 | 9.68 | 9.67 | 9.65 | 9.61 |
| Calcium, % | 1.00 | 1.00 | 1.00 | 1.00 | 1.00 |
| Phosphorus, % | 0.75 | 0.75 | 0.75 | 0.75 | 0.75 |
| Lysine, % | 1.60 | 1.60 | 1.60 | 1.60 | 1.60 |

TABLE 6
Composition of Stage 3 Diets

| | Treatment | | | | |
|---|---|---|---|---|---|
| | 1 | 2 | 3 | 4 | 5 |
| Ingredients, weight % | | | | | |
| Grain Products | 51.11 | 51.01 | 50.91 | 50.81 | 50.51 |
| Plant Protein | 24.20 | 24.20 | 24.20 | 24.20 | 24.20 |
| Animal Protein | 11.12 | 11.12 | 11.12 | 11.12 | 11.12 |
| Grain By-Products | 5.00 | 3.00 | 3.00 | 3.00 | 3.00 |
| Fat | 2.89 | 2.89 | 2.89 | 2.89 | 2.89 |
| Others | 5.68 | 5.68 | 5.68 | 5.68 | 5.68 |
| Wheat Dextrin | — | 0.10 | 0.20 | 0.30 | 0.60 |
| Total | 100.00 | 100.00 | 100.00 | 100.00 | 100.00 |
| Calculated Nutrient | | | | | |
| Analysis | | | | | |
| Protein, % | 20.51 | 20.50 | 20.49 | 20.48 | 20.46 |
| Fat; Crude, % | 5.74 | 5.73 | 5.73 | 5.72 | 5.71 |
| Fiber, % | 2.58 | 2.58 | 2.58 | 2.58 | 2.57 |
| Dry Matter, % | 89.02 | 89.03 | 89.05 | 89.06 | 89.10 |
| Moisture, % | 10.98 | 10.97 | 10.95 | 10.94 | 10.90 |
| Calcium, % | 0.85 | 0.85 | 0.85 | 0.85 | 0.85 |
| Phosphorus, % | 0.70 | 0.70 | 0.70 | 0.70 | 0.70 |
| Lysine, % | 1.40 | 1.40 | 1.40 | 1.40 | 1.40 |

TABLE 7
Composition of Stage 4 Diets

| | Treatment | | | | |
|---|---|---|---|---|---|
| | 1 | 2 | 3 | 4 | 5 |
| Ingredients, % | | | | | |
| Grain Products | 54.15 | 54.05 | 53.95 | 53.85 | 53.55 |
| Plant Protein | 28.34 | 28.34 | 28.34 | 28.34 | 28.34 |
| Roughage | 4.56 | 4.56 | 4.56 | 4.56 | 4.56 |
| Grain By-Products | 3.00 | 3.00 | 3.00 | 3.00 | 3.00 |
| Animal Protein | 3.00 | 3.00 | 3.00 | 3.00 | 3.00 |
| Fat | 3.40 | 3.40 | 3.40 | 3.40 | 3.40 |
| Others | 3.55 | 3.55 | 3.55 | 3.55 | 3.55 |
| Wheat Dextrin | — | 0.10 | 0.20 | 0.30 | 0.60 |
| Total | 100.00 | 100.00 | 100.00 | 100.00 | 100.00 |
| Calculated Nutrient | | | | | |
| Analysis | | | | | |
| Protein, % | 20.18 | 20.17 | 20.16 | 20.15 | 20.13 |
| Fat; Crude, % | 6.25 | 6.25 | 6.24 | 6.24 | 6.23 |
| Fiber, % | 4.66 | 4.66 | 4.66 | 4.65 | 4.65 |
| Dry Matter, % | 88.44 | 88.45 | 88.47 | 88.48 | 88.52 |
| Moisture, % | 11.56 | 11.55 | 11.53 | 11.52 | 11.48 |
| Calcium, % | 0.90 | 0.90 | 0.90 | 0.90 | 0.90 |
| Phosphorus, % | 0.71 | 0.71 | 0.71 | 0.71 | 0.70 |
| Lysine, % | 1.30 | 1.30 | 1.30 | 1.30 | 1.30 |

TABLE 8
Effect of Inclusion Level of Wheat Dextrin in Medicated Nursery Diets

| | Treatment No. | | | | | | | | | | |
|---|---|---|---|---|---|---|---|---|---|---|---|
| | 1 | 2 | 3 | 4 | 5 | | | P Values | | | P Values |
| | Wheat Dextrin, kg/tonne (lb/ton) | | | | | | | Wheat Dextrin | | | for Pair-wise |
| | 0 (0) | 1 (2) | 2 (4) | 3 (6) | 6 (12) | Mean | Stderr | Linear | Quadratic | Cubic | Comparison¹ |
| No. pens/trt | 6 | 6 | 6 | 6 | 6 | | | | | | |
| No. pigs/trt | 30(1)* | 30 | 30(1) | 30(3) | 30(1) | | | | | | |
| Weight, kg | | | | | | | | | | | |
| Initial | 4.16 | 4.13 | 4.16 | 4.15 | 4.17 | 4.15 | 0.20 | | | | |
| Stage 1, 7 d | 5.07 | 5.18 | 5.10 | 5.09 | 5.08 | 5.10 | 0.13 | 0.854 | 0.911 | 0.642 | |
| Stage 2, 7 d | 6.64 | 6.75 | 6.60 | 6.80 | 6.68 | 6.69 | 0.21 | 0.939 | 0.785 | 0.846 | |
| Stage 3, 14 d | 13.03 | 13.14 | 13.56 | 13.23 | 12.96 | 13.19 | 0.39 | 0.789 | 0.361 | 0.805 | |
| Stage 4, 14 d | 22.16 | 22.30 | 23.07 | 22.60 | 22.19 | 22.46 | 0.50 | 0.936 | 0.235 | 0.850 | |
| Daily gain, kg | | | | | | | | | | | |
| Stage 1, 7 d | 0.131 | 0.150 | 0.134 | 0.134 | 0.131 | 0.136 | 0.016 | 0.727 | 0.835 | 0.505 | |
| Stage 2, 7 d | 0.224 | 0.225 | 0.214 | 0.245 | 0.227 | 0.227 | 0.016 | 0.721 | 0.713 | 0.365 | |
| Stage 3, 14 d | 0.456 | 0.456 | 0.498 | 0.460 | 0.449 | 0.464 | 0.016 | 0.595 | 0.182 | 0.545 | behl |
| Stage 4, 14 d | 0.652 | 0.654 | 0.679 | 0.669 | 0.659 | 0.663 | 0.016 | 0.777 | 0.286 | 0.993 | |
| Overall, S1-2 | 0.178 | 0.187 | 0.174 | 0.189 | 0.179 | 0.182 | 0.014 | 0.997 | 0.737 | 0.889 | |
| Overall, S1-3 | 0.317 | 0.322 | 0.336 | 0.324 | 0.314 | 0.323 | 0.014 | 0.756 | 0.342 | 0.775 | |
| Overall, S1-4 | 0.429 | 0.433 | 0.450 | 0.439 | 0.429 | 0.436 | 0.012 | 0.914 | 0.241 | 0.834 | |
| Feed intake, kg/d | | | | | | | | | | | |
| Stage 1, 7 d | 0.194 | 0.161 | 0.175 | 0.169 | 0.192 | 0.178 | 0.017 | 0.700 | 0.216 | 0.551 | |
| Stage 2, 7 d | 0.326 | 0.317 | 0.332 | 0.310 | 0.311 | 0.319 | 0.014 | 0.401 | 0.974 | 0.736 | |
| Stage 3, 14 d | 0.672 | 0.645 | 0.683 | 0.637 | 0.641 | 0.656 | 0.022 | 0.336 | 0.900 | 0.816 | |
| Stage 4, 14 d | 1.087 | 0.986 | 1.028 | 1.022 | 1.036 | 1.031 | 0.028 | 0.659 | 0.144 | 0.125 | A |
| Overall, S1-2 | 0.259 | 0.239 | 0.253 | 0.237 | 0.251 | 0.248 | 0.013 | 0.859 | 0.340 | 0.936 | |
| Overall, S1-3 | 0.464 | 0.442 | 0.465 | 0.430 | 0.445 | 0.449 | 0.018 | 0.492 | 0.545 | 0.757 | |
| Overall, S1-4 | 0.670 | 0.623 | 0.650 | 0.618 | 0.638 | 0.640 | 0.019 | 0.403 | 0.196 | 0.758 | ac |
| Feed/gain | | | | | | | | | | | |
| Stage 1, 7 d | 1.565 | 1.090 | 1.561 | 1.340 | 1.758 | 1.463 | 0.195 | 0.187 | 0.263 | 0.503 | aeG |
| Stage 2, 7 d | 1.534 | 1.442 | 1.599 | 1.386 | 1.376 | 1.467 | 0.064 | 0.073 | 0.905 | 0.561 | deHI |
| Stage 3, 14 d | 1.472 | 1.418 | 1.395 | 1.427 | 1.455 | 1.433 | 0.027 | 0.892 | 0.072 | 0.272 | b |
| Stage 4, 14 d | 1.665 | 1.510 | 1.512 | 1.527 | 1.571 | 1.557 | 0.030 | 0.325 | 0.002 | 0.041 | ABCD |
| Overall, S1-2 | 1.533 | 1.294 | 1.537 | 1.350 | 1.450 | 1.433 | 0.077 | 0.830 | 0.355 | 0.597 | AcEh |
| Overall, S1-3 | 1.487 | 1.378 | 1.422 | 1.403 | 1.445 | 1.427 | 0.027 | 0.863 | 0.036 | 0.161 | AbCg |
| Overall, S1-4 | 1.575 | 1.443 | 1.466 | 1.466 | 1.509 | 1.492 | 0.024 | 0.508 | 0.002 | 0.036 | ABCdg |

*Numbers in parentheses are numbers of pigs removed during the trial.
¹A lower case letter refers to .05 < P < .10 and an upper case letter refers to P < .05.
A or a = Trt 1 vs. Trt 2
B or b = Trt 1 vs. Trt 3
C or c = Trt 1 vs. Trt 4
D or d = Trt 1 vs. Trt 5
E or e = Trt 2 vs. Trt 3
F or f = Trt 2 vs. Trt 4
G or g = Trt 2 vs. Trt 5
H or h = Trt 3 vs. Trt 4
I or i = Trt 3 vs. Trt 5
J or j = Trt 4 vs. Trt 5

Compared to the negative control diets having no soluble dextrin, the addition of 2 kg of soluble dextrin per tonne of feed (4 lbs of soluble dextrin per ton of feed) improved daily gain in stage 3 (P<0.10), and the addition of 1 kg of soluble dextrin per tonne of feed (2 lbs of soluble dextrin per ton of feed) decreased the average daily feed intake in stage 4 (P<0.05) and the cumulative stage 1 to 4. The addition of 3 kg of soluble dextrin per tonne of feed (6 lbs of soluble dextrin per ton of feed) also decreased the overall feed intake (treatment 4 vs. treatment 1, P<0.10). FIG. 1 presents a bar graph illustrating that the inclusion of the soluble dextrin product in the animal feed at all examined levels resulted in increased body weight at the end of the study (day 42). An increase of 0.91 kg (2 lbs) in body weight occurred with soluble dextrin inclusion levels of 2 kg of soluble dextrin per tonne of feed (4 lbs of soluble dextrin per ton of feed). FIG. 2 illustrates the feed efficiency (feed/gain) for treatments 1-5 for the first half of the study (days 1-14) and the total study (days 1-42). A feed efficiency improvement of up to 7% was observed with soluble dextrin inclusion levels of 2 kg of soluble dextrin per tonne of feed (4 lbs of soluble dextrin per ton of feed). All soluble dextrin inclusion levels examined had feed efficiency values less than the control, which indicates a better nutrient utilization for pigs fed the feed composition containing the soluble dextrin.

Polynomial analysis demonstrated that increasing the dietary soluble dextrin inclusion levels had a linear improvement of feed efficiency in phase 2 (P<0.08), a quadratic effect in stage 3 (P<0.08), stage 4 (P<0.01), cumulative stages 1 to 3 (P<0.05) and stages 1 to 4 (P<0.01), and a cubic effect in stage 4 (P<0.05) and cumulative stages 1 to 4 (P<0.05). Pair-wise comparisons indicated that the addition of 1, 2, or 3 kg of soluble dextrin per tonne of feed (2, 4, or 6 lbs of soluble dextrin per ton of feed) improved the feed efficiency in most individual phases and overall as compared to the addition of 0 kg of soluble dextrin per tonne of feed (0 lbs of soluble dextrin per ton of feed) (P<0.05 or P<0.10).

This Example demonstrates that the addition of a soluble wheat dextrin product to an animal feed composition in quantities of 1 kg to 6 kg of soluble dextrin per tonne of feed (2 to 12 lbs of soluble dextrin per ton of feed) results in improved average daily gain, body weight gain, and feed efficiency, and decreased average daily feed intake over a control diet.

### Example 5

### Dextrin and Antibiotics

This Example compares the effect of the addition of the soluble dextrin and/or antibiotics to animal feed compositions on the performance of growing-finishing pigs fed a diet of the animal feed compositions. In this Example, Tylan® was used as the antibiotic. The effect on average daily gain (“ADG”), average daily feed intake (“ADFI”), weight increase, and gut microbial populations are disclosed.

A total of 175 grower pigs (average initial weight/pig=20.65 kg) were used to evaluate the effects of animal feed compositions comprising the soluble wheat dextrin and/or antibiotics on the performance of growing-finishing pigs fed a diet of the animal feed compositions. Pigs were randomly allotted to five dietary treatments, with seven pens per treatment and five pigs per pen. There were 20 gilts and 15 barrows for each treatment. A split-sex feeding program was used. Dietary treatments were configured as a 2×2 factorial arrangement. The four dietary treatments were: 1) Control diet without Tylan® or the soluble dextrin; 2) Control diet+the soluble dextrin at 2.5 kg of soluble dextrin per tonne of feed (5.0 lbs of soluble dextrin per ton of feed); 3) Control diet+Tylan® at 44.1 g of Tylan® per tonne of feed (40 g of Tylan® per ton of feed); and 4) Control diet+the soluble dextrin and Tylan®, each at the above levels. The control diets were typical corn-soy rations. Dietary D/A lysine (i.e., digestible/available lysine) was 1.15%, 1.05%, 0.95%, 0.85%, and 0.75% for grower 1, grower 2, grower 3, finisher 1, and finisher 2 stages, respectively. Grower diets were formulated to contain 14,235 kJ/kg (3400 kcal/kg) of metabolizable energy (“ME”), while finisher diets contained 13,816 kJ/kg (3300 kcal/kg) of ME. Pigs and feeders were weighed on days 1, 17, 38, 59, 80, and 101 of the study, concurrent with diet changes. The study was discontinued on the same day for all pigs (day 101). On the last day of the study, fresh fecal samples were collected from pigs in treatments 1 and 2 (i.e., control and control+the soluble dextrin). One medium-sized pig was selected from each pen to collect the fresh fecal samples. A total of 14 fecal samples were collected and submitted to microbial analysis. Diet compositions for each diet treatment and stage are listed in Tables 9-13. Results from this Example are listed by treatment in Tables 14 and overall results are listed in Table 15.

TABLE 9
Composition of Grower 1 Diets

| | Treatment | | | |
|---|---|---|---|---|
| | 1 | 2 | 3 | 4 |
| Ingredients (weight %) | | | | |
| Grain Products | 61.88 | 61.64 | 61.87 | 61.62 |
| Plant Protein | 32.89 | 32.89 | 32.89 | 32.89 |
| Fat | 2.15 | 2.15 | 2.15 | 2.15 |
| Others | 3.08 | 3.07 | 3.07 | 3.07 |
| Wheat Dextrin | — | 0.25 | — | 0.25 |
| Tylan ® 100 | — | — | 0.02 | 0.02 |
| Total | 100.00 | 100.00 | 100.00 | 100.00 |
| Calculated Nutrient Analysis | | | | |
| Protein, % | 21.02 | 21.00 | 21.02 | 21.00 |
| Fat; Crude, % | 4.41 | 4.40 | 4.41 | 4.40 |
| Crude Fiber, % | 2.70 | 2.69 | 2.70 | 2.69 |
| Dry Matter, % | 89.82 | 89.84 | 89.82 | 89.84 |
| Moisture, % | 10.18 | 10.16 | 10.18 | 10.16 |
| Calcium, % | 0.80 | 0.80 | 0.80 | 0.80 |
| Phosphorus, % | 0.60 | 0.60 | 0.60 | 0.60 |
| Lysine, % | 1.35 | 1.35 | 1.35 | 1.35 |

TABLE 10
Composition of Grower 2 Diets

| | Treatment | | | |
|---|---|---|---|---|
| | 1 | 2 | 3 | 4 |
| Ingredients (weight %) | | | | |
| Grain Products | 64.10 | 63.84 | 64.07 | 63.82 |
| Plant Protein | 30.35 | 30.35 | 30.35 | 30.35 |
| Fat | 2.28 | 2.28 | 2.28 | 2.28 |
| Others | 3.27 | 3.28 | 3.28 | 3.28 |
| Wheat Dextrin | — | 0.25 | — | 0.25 |
| Tylan ® 100 | — | — | 0.02 | 0.02 |
| Total | 100.00 | 100.00 | 100.00 | 100.00 |
| Calculated Nutrient Analysis | | | | |
| Protein, % | 19.93 | 19.91 | 19.93 | 19.91 |
| Fat; Crude, % | 4.57 | 4.56 | 4.57 | 4.56 |
| Crude Fiber, % | 2.54 | 2.53 | 2.54 | 2.53 |
| Dry Matter, % | 89.90 | 89.92 | 89.90 | 89.92 |
| Moisture, % | 10.10 | 10.08 | 10.10 | 10.08 |
| Calcium, % | 0.75 | 0.75 | 0.75 | 0.75 |
| Phosphorus, % | 0.55 | 0.55 | 0.55 | 0.55 |
| Lysine, % | 1.25 | 1.25 | 1.25 | 1.25 |

TABLE 11
Composition of Grower 3 Diets

| | Treatment | | | |
|---|---|---|---|---|
| | 1 | 2 | 3 | 4 |
| Ingredients (weight %) | | | | |
| Grain Products | 68.03 | 67.77 | 68.00 | 67.75 |
| Plant Protein | 27.77 | 27.77 | 27.77 | 27.77 |
| Fat | 1.68 | 1.68 | 1.68 | 1.68 |
| Others | 2.52 | 2.53 | 2.53 | 2.53 |
| Wheat Dextrin | — | 0.25 | — | 0.25 |
| Tylan ® 100 | — | — | 0.02 | 0.02 |
| Total | 100.00 | 100.00 | 100.00 | 100.00 |
| Calculated Nutrient Analysis | | | | |
| Protein, % | 18.82 | 18.80 | 18.82 | 18.80 |
| Fat; Crude, % | 4.06 | 4.05 | 4.06 | 4.05 |
| Crude Fiber, % | 2.67 | 2.67 | 2.67 | 2.67 |
| Dry Matter, % | 89.83 | 89.85 | 89.83 | 89.85 |
| Moisture, % | 10.17 | 10.15 | 10.17 | 10.15 |
| Calcium, % | 0.65 | 0.65 | 0.65 | 0.65 |
| Phosphorus, % | 0.55 | 0.55 | 0.55 | 0.55 |
| Lysine, % | 1.14 | 1.14 | 1.14 | 1.14 |

TABLE 12
Composition of Finisher 1 Diets

| | Treatment | | | |
|---|---|---|---|---|
| | 1 | 2 | 3 | 4 |
| Ingredients (weight %) | | | | |
| Grain Products | 72.11 | 71.86 | 72.09 | 71.84 |
| Plant Protein | 24.85 | 24.85 | 24.85 | 24.85 |
| Others | 3.04 | 3.04 | 3.04 | 3.04 |
| Wheat Dextrin | — | 0.25 | — | 0.25 |
| Tylan ® 100 | — | — | 0.02 | 0.02 |
| Total | 100.00 | 100.00 | 100.00 | 100.00 |
| Calculated Nutrient Analysis | | | | |
| Protein, % | 17.82 | 17.80 | 17.82 | 17.80 |
| Fat; Crude, % | 2.47 | 2.47 | 2.47 | 2.47 |
| Crude Fiber, % | 2.53 | 2.52 | 2.53 | 2.52 |
| Dry Matter, % | 89.77 | 89.79 | 89.77 | 89.80 |
| Moisture, % | 10.23 | 10.21 | 10.23 | 10.20 |
| Calcium, % | 0.60 | 0.60 | 0.60 | 0.60 |
| Phosphorus, % | 0.50 | 0.50 | 0.50 | 0.50 |
| Lysine, % | 1.03 | 1.03 | 1.03 | 1.03 |

TABLE 13
Composition of Finisher 2 Diets

| | Treatment | | | |
|---|---|---|---|---|
| | 1 | 2 | 3 | 4 |
| Ingredients (weight %) | | | | |
| Grain Products | 78.68 | 78.44 | 78.67 | 78.42 |
| Plant Protein | 18.71 | 18.71 | 18.71 | 18.71 |
| Others | 2.61 | 2.60 | 2.60 | 2.60 |
| Wheat Dextrin | — | 0.25 | — | 0.25 |
| Tylan ® 100 | — | — | 0.02 | 0.02 |
| Total | 100.00 | 100.00 | 100.00 | 100.00 |
| Calculated Nutrient Analysis | | | | |
| Protein, % | 15.48 | 15.46 | 15.48 | 15.46 |
| Fat; Crude, % | 2.99 | 2.98 | 2.99 | 2.98 |
| Crude Fiber, % | 2.32 | 2.32 | 2.32 | 2.32 |
| Dry Matter, % | 89.26 | 89.28 | 89.26 | 89.28 |
| Moisture, % | 10.74 | 10.72 | 10.74 | 10.72 |
| Calcium, % | 0.60 | 0.60 | 0.60 | 0.60 |
| Phosphorus, % | 0.50 | 0.50 | 0.50 | 0.50 |
| Lysine, % | 0.91 | 0.91 | 0.91 | 0.91 |

TABLE 14
Effects of Dextrin and Antibiotics on Performance of Growing-Finishing Pigs:
Effect on Growth Performance of Barrows and Gilts

| | Treatment No. | | | | | | | |
|---|---|---|---|---|---|---|---|---|
| | 1 | 2 | 3 | 4 | 1 | 2 | 3 | 4 |
| | Sex | | | | | | | |
| | Barrow | Barrow | Barrow | Barrow | Gilt | Gilt | Gilt | Gilt |
| | Dextrin, kg/tonne (lbs/ton) | | | | | | | |
| | 0 (0) | 2.5 (5) | 0 (0) | 2.5 (5) | 0 (0) | 2.5 (5) | 0 (0) | 2.5 (5) |
| | Medication | | | | | | | |
| | 0 | 0 | Tylan | Tylan | 0 | 0 | Tylan | Tylan |
| No. of pigs/trt | 15 | 15 | 14 | 15 | 20 | 20 | 20 | 20 |
| Initial weight, kg | 20.30 | 20.30 | 20.30 | 20.30 | 21.00 | 21.00 | 21.00 | 21.00 |
| Grower 1 weight, kg | 36.16 | 36.03 | 36.88 | 36.64 | 35.63 | 35.72 | 35.04 | 34.89 |
| Grower 2 weight, kg | 56.64 | 57.52 | 57.49 | 57.15 | 54.64 | 55.66 | 54.09 | 53.05 |
| Grower 3 weight, kg | 74.25 | 76.70 | 75.50 | 73.97 | 72.25 | 73.62 | 71.63 | 70.71 |
| Finisher 1 weight, kg | 95.52 | 97.43 | 90.88 | 96.68 | 90.28 | 93.34 | 90.36 | 90.54 |
| Finisher 2 weight, kg | 114.79 | 119.83 | 119.84 | 119.04 | 109.17 | 111.51 | 109.62 | 110.15 |
| Average daily | | | | | | | | |
| feed intake, kg | | | | | | | | |
| Grower 1 - 17 days | 1.44 | 1.47 | 1.44 | 1.45 | 1.41 | 1.41 | 1.37 | 1.35 |
| Grower 2 - 21 days | 2.14 | 2.20 | 2.07 | 2.17 | 1.90 | 1.99 | 1.92 | 1.87 |
| Grower 3 - 21 days | 2.47 | 2.60 | 2.32 | 2.41 | 2.16 | 2.27 | 2.22 | 2.12 |
| Finisher 1 - 21 days | 2.81 | 3.03 | 2.88 | 2.82 | 2.55 | 2.60 | 2.46 | 2.50 |
| Finisher 2 - 21 days | 3.30 | 3.57 | 3.53 | 3.53 | 2.89 | 2.69 | 2.92 | 2.86 |
| Combined - 101 days | 2.45 | 2.61 | 2.47 | 2.47 | 2.19 | 2.20 | 2.20 | 2.14 |
| Average daily gain, kg | | | | | | | | |
| Grower 1 | 0.81 | 0.81 | 0.84 | 0.84 | 0.78 | 0.82 | 0.78 | 0.77 |
| Grower 2 | 0.97 | 1.02 | 0.98 | 0.98 | 0.89 | 0.95 | 0.91 | 0.86 |
| Grower 3 | 0.88 | 0.96 | 0.91 | 0.85 | 0.84 | 0.91 | 0.88 | 0.86 |
| Finisher 1 | 0.94 | 0.99 | 0.96 | 0.93 | 0.86 | 0.94 | 0.89 | 0.88 |
| Finisher 2 | 0.92 | 1.07 | 1.06 | 1.06 | 0.90 | 0.86 | 0.92 | 0.93 |
| Combined | 0.91 | 0.98 | 0.95 | 0.93 | 0.86 | 0.90 | 0.88 | 0.86 |
| Feed:gain ratio | | | | | | | | |
| Grower 1 | 1.77 | 1.83 | 1.71 | 1.72 | 1.79 | 1.72 | 1.76 | 1.75 |
| Grower 2 | 2.21 | 2.17 | 2.12 | 2.22 | 2.13 | 2.09 | 2.12 | 2.16 |
| Grower 3 | 2.82 | 2.70 | 2.55 | 2.87 | 2.58 | 2.49 | 2.53 | 2.48 |
| Finisher 1 | 3.01 | 3.07 | 3.07 | 3.06 | 2.96 | 2.77 | 2.76 | 2.85 |
| Finisher 2 | 3.59 | 3.34 | 3.34 | 3.32 | 3.21 | 3.14 | 3.18 | 3.07 |
| Combined | 2.70 | 2.68 | 2.59 | 2.65 | 2.55 | 2.45 | 2.51 | 2.48 |

| | P Values | | | | | | |
|---|---|---|---|---|---|---|---|
| | | | | | | | Sex × |
| | | | Sex × | | | Dextrin × | Dextrin × |
| | Sex | Dextrin | Dextrin | Med | Sex × Med | Med | Med |
| No. of pigs/trt | | | | | | | |
| Initial weight, kg | | | | | | | |
| Grower 1 weight, kg | 0.0146 | 0.7800 | 0.8522 | 0.9523 | 0.0883 | 0.8140 | 0.9335 |
| Grower 2 weight, kg | <0.0001 | 0.8055 | 0.7880 | 0.2093 | 0.0948 | 0.1283 | 0.6853 |
| Grower 3 weight, kg | 0.0303 | 0.7805 | 0.9239 | 0.3134 | 0.6766 | 0.2113 | 0.7276 |
| Finisher 1 weight, kg | 0.0415 | 0.1232 | 0.5179 | 0.2471 | 0.6986 | 0.8821 | 0.3309 |
| Finisher 2 weight, kg | 0.0002 | 0.2893 | 0.8354 | 0.6143 | 0.4385 | 0.2563 | 0.5427 |
| Average daily | | | | | | | |
| feed intake, kg | | | | | | | |
| Grower 1 - 17 days | 0.0675 | 0.8472 | 0.6101 | 0.4011 | 0.5945 | 0.6967 | 0.9528 |
| Grower 2 - 21 days | 0.0002 | 0.2689 | 0.5313 | 0.2807 | 0.9744 | 0.5998 | 0.3385 |
| Grower 3 - 21 days | 0.0069 | 0.4903 | 0.5305 | 0.1861 | 0.4596 | 0.4506 | 0.6040 |
| Finisher 1 - 21 days | 0.0008 | 0.4811 | 0.8220 | 0.3406 | 0.8843 | 0.3914 | 0.4064 |
| Finisher 2 - 21 days | 0.0003 | 0.9847 | 0.3351 | 0.4768 | 0.9857 | 0.8173 | 0.4522 |
| Combined - 101 days | <0.0001 | 0.6208 | 0.4021 | 0.4391 | 0.7148 | 0.3235 | 0.7392 |
| Average daily gain, kg | | | | | | | |
| Grower 1 | 0.1019 | 0.8582 | 0.6936 | 0.8996 | 0.1837 | 0.6623 | 0.5886 |
| Grower 2 | 0.0021 | 0.4744 | 0.6927 | 0.2462 | 0.6785 | 0.1153 | 0.5516 |
| Grower 3 | 0.4674 | 0.6092 | 0.8019 | 0.4574 | 0.5503 | 0.1304 | 0.7318 |
| Finisher 1 | 0.1356 | 0.5358 | 0.7499 | 0.7083 | 0.9488 | 0.2508 | 0.9926 |
| Finisher 2 | 0.0160 | 0.4476 | 0.3221 | 0.2079 | 0.7444 | 0.6009 | 0.2607 |
| Combined | 0.0022 | 0.3169 | 0.8100 | 0.7779 | 0.8192 | 0.0518 | 0.6535 |
| Feed:gain ratio | | | | | | | |
| Grower 1 | 0.9650 | 0.9753 | 0.0408 | 0.0269 | 0.0285 | 0.7299 | 0.1031 |
| Grower 2 | 0.2696 | 0.7248 | 0.7320 | 0.9175 | 0.5799 | 0.1999 | 0.7475 |
| Grower 3 | 0.0010 | 0.7446 | 0.1134 | 0.4432 | 0.9441 | 0.0323 | 0.0673 |
| Finisher 1 | 0.0112 | 0.8566 | 0.5749 | 0.7780 | 0.5795 | 0.4707 | 0.2252 |
| Finisher 2 | 0.0269 | 0.2730 | 0.8317 | 0.3482 | 0.6346 | 0.6194 | 0.4854 |
| Combined | <0.0001 | 0.4743 | 0.1853 | 0.2520 | 0.2802 | 0.1668 | 0.9434 |

TABLE 15
Effects of Dextrin and Antibiotics on Performance of Growing-Finishing Pigs:
Main Effects of Growth Performance

| | | | Dextrin, kg/tonne | | | | | | |
|---|---|---|---|---|---|---|---|---|---|
| | Sex | | (lbs/ton) | | Medication | | | | |
| | Barrows | Gilts | 0 (0) | 2.5 (5) | 0 | Tylan | Mean | R² | CV, % |
| No. of pigs/trt | 59 | 80 | 69 | 70 | 70 | 69 | | | |
| Initial weight, kg | 20.30 | 21.00 | 20.70 | 20.70 | 20.70 | 20.70 | | | |
| Grower 1 weight, kg | 36.43 | 35.32 | 35.93 | 35.82 | 35.88 | 35.86 | 34.94 | 0.94 | 2.84 |
| Grower 2 weight, kg | 57.20 | 54.36 | 55.72 | 55.84 | 56.11 | 55.45 | 54.75 | 0.90 | 2.44 |
| Grower 3 weight, kg | 75.11 | 72.05 | 73.41 | 73.75 | 74.21 | 72.95 | 72.46 | 0.63 | 4.34 |
| Finisher 1 weight, kg | 95.13 | 91.13 | 91.76 | 94.50 | 94.14 | 92.12 | 92.08 | 0.48 | 4.79 |
| Finisher 2 weight, kg | 118.37 | 110.11 | 113.35 | 115.13 | 113.82 | 114.66 | 112.86 | 0.68 | 3.76 |
| Average daily | | | | | | | | | |
| feed intake, kg | | | | | | | | | |
| Grower 1 - 17 days | 1.45 | 1.38 | 1.41 | 1.42 | 1.43 | 1.40 | 1.38 | 0.78 | 6.02 |
| Grower 2 - 21 days | 2.14 | 1.92 | 2.01 | 2.06 | 2.06 | 2.01 | 2.00 | 0.70 | 5.82 |
| Grower 3 - 21 days | 2.45 | 2.19 | 2.29 | 2.35 | 2.38 | 2.27 | 2.28 | 0.47 | 8.99 |
| Finisher 1 - 21 days | 2.89 | 2.53 | 2.68 | 2.74 | 2.75 | 2.67 | 2.67 | 0.57 | 7.99 |
| Finisher 2 - 21 days | 3.48 | 2.84 | 3.16 | 3.16 | 3.11 | 3.21 | 3.11 | 0.60 | 11.14 |
| Combined - 101 days | 2.50 | 2.18 | 2.33 | 2.35 | 2.36 | 2.32 | 2.30 | 0.65 | 6.40 |
| Average daily gain, kg | | | | | | | | | |
| Grower 1 | 0.83 | 0.79 | 0.81 | 0.81 | 0.81 | 0.81 | 0.79 | 0.58 | 6.81 |
| Grower 2 | 0.99 | 0.90 | 0.94 | 0.95 | 0.96 | 0.93 | 0.94 | 0.63 | 6.02 |
| Grower 3 | 0.90 | 0.87 | 0.88 | 0.89 | 0.90 | 0.87 | 0.88 | 0.24 | 10.64 |
| Finisher 1 | 0.96 | 0.89 | 0.91 | 0.94 | 0.93 | 0.92 | 0.92 | 0.40 | 10.56 |
| Finisher 2 | 1.03 | 0.90 | 0.95 | 0.98 | 0.94 | 0.99 | 0.96 | 0.44 | 11.67 |
| Combined | 0.94 | 0.87 | 0.90 | 0.92 | 0.91 | 0.91 | 0.90 | 0.53 | 5.03 |
| Feed:gain ratio | | | | | | | | | |
| Grower 1 | 1.76 | 1.75 | 1.75 | 1.76 | 1.78 | 1.73 | 1.74 | 0.79 | 2.51 |
| Grower 2 | 2.18 | 2.13 | 2.15 | 2.16 | 2.15 | 2.16 | 2.12 | 0.66 | 5.06 |
| Grower 3 | 2.74 | 2.52 | 2.62 | 2.64 | 2.65 | 2.61 | 2.61 | 0.70 | 5.08 |
| Finisher 1 | 3.05 | 2.83 | 2.95 | 2.94 | 2.95 | 2.93 | 2.90 | 0.61 | 6.44 |
| Finisher 2 | 3.40 | 3.15 | 3.33 | 3.22 | 3.32 | 3.23 | 3.26 | 0.41 | 7.69 |
| Combined | 2.66 | 2.50 | 2.59 | 2.57 | 2.59 | 2.56 | 2.55 | 0.75 | 2.88 |

| | P Values | | | | | | |
|---|---|---|---|---|---|---|---|
| | | | Sex × | | | Dextrin × | Sex × |
| | Sex | Dextrin | Dextrin | Med | Sex × Med | Med | Dextrin × Med |
| No. of pigs/trt | | | | | | | |
| Initial weight, kg | | | | | | | |
| Grower 1 weight, kg | 0.0146 | 0.7800 | 0.8522 | 0.9523 | 0.0883 | 0.8140 | 0.9335 |
| Grower 2 weight, kg | <0.0001 | 0.8055 | 0.7880 | 0.2093 | 0.0948 | 0.1283 | 0.6853 |
| Grower 3 weight, kg | 0.0303 | 0.7805 | 0.9239 | 0.3134 | 0.6766 | 0.2113 | 0.7276 |
| Finisher 1 weight, kg | 0.0415 | 0.1232 | 0.5179 | 0.2471 | 0.6986 | 0.8821 | 0.3309 |
| Finisher 2 weight, kg | 0.0002 | 0.2893 | 0.8354 | 0.6143 | 0.4385 | 0.2563 | 0.5427 |
| Average daily | | | | | | | |
| feed intake, kg | | | | | | | |
| Grower 1 - 17 days | 0.0675 | 0.8472 | 0.6101 | 0.4011 | 0.5945 | 0.6967 | 0.9528 |
| Grower 2 - 21 days | 0.0002 | 0.2689 | 0.5313 | 0.2807 | 0.9744 | 0.5998 | 0.3385 |
| Grower 3 - 21 days | 0.0069 | 0.4903 | 0.5305 | 0.1861 | 0.4596 | 0.4506 | 0.6040 |
| Finisher 1 - 21 days | 0.0008 | 0.4811 | 0.8220 | 0.3406 | 0.8843 | 0.3914 | 0.4064 |
| Finisher 2 - 21 days | 0.0003 | 0.9847 | 0.3351 | 0.4768 | 0.9857 | 0.8173 | 0.4522 |
| Combined - 101 days | <0.0001 | 0.6208 | 0.4021 | 0.4391 | 0.7148 | 0.3235 | 0.7392 |
| Average daily gain, kg | | | | | | | |
| Grower 1 | 0.1019 | 0.8582 | 0.6936 | 0.8996 | 0.1837 | 0.6623 | 0.5886 |
| Grower 2 | 0.0021 | 0.4744 | 0.6927 | 0.2462 | 0.6785 | 0.1153 | 0.5516 |
| Grower 3 | 0.4674 | 0.6092 | 0.8019 | 0.4574 | 0.5503 | 0.1304 | 0.7318 |
| Finisher 1 | 0.1356 | 0.5358 | 0.7499 | 0.7083 | 0.9488 | 0.2508 | 0.9926 |
| Finisher 2 | 0.0160 | 0.4476 | 0.3221 | 0.2079 | 0.7444 | 0.6009 | 0.2607 |
| Combined | 0.0022 | 0.3169 | 0.8100 | 0.7779 | 0.8192 | 0.0518 | 0.6535 |
| Feed:gain ratio | | | | | | | |
| Grower 1 | 0.9650 | 0.9753 | 0.0408 | 0.0269 | 0.0285 | 0.7299 | 0.1031 |
| Grower 2 | 0.2696 | 0.7248 | 0.7320 | 0.9175 | 0.5799 | 0.1999 | 0.7475 |
| Grower 3 | 0.0010 | 0.7446 | 0.1134 | 0.4432 | 0.9441 | 0.0323 | 0.0673 |
| Finisher 1 | 0.0112 | 0.8566 | 0.5749 | 0.7780 | 0.5795 | 0.4707 | 0.2252 |
| Finisher 2 | 0.0269 | 0.2730 | 0.8317 | 0.3482 | 0.6346 | 0.6194 | 0.4854 |
| Combined | <0.0001 | 0.4743 | 0.1853 | 0.2520 | 0.2802 | 0.1668 | 0.9434 |

The main effects of Tylan® on average daily gain (ADG), average daily feed intake (ADFI), and feed:gain ratio were not significant throughout the study (Tables 14 and 15). However, the addition of 44.1 grams of Tylan® per tonne of feed (40 grams of Tylan® per ton of feed) improved the feed:gain ratio in the Grower 1 phase (P<0.05). There were also significant interactions between Tylan® and dextrin on the overall daily gain and feed efficiency in the Grower 3 phase. Further examination of the data revealed that dextrin appeared to improve the daily gain in non-medicated diets. The addition of 2.5 kg of dextrin per tonne of feed (5 lbs of dextrin per ton of feed) into non-medicated diets increased final body weight by approximately 5.0 kg for barrows and approximately 2.5 kg for gilts. The addition of Tylan® increased body weight by approximately 5.0 kg for barrows and approximately 0.5 kg for gilts. This data indicates that dextrin improved ADG and body weight more than Tylan® in this study. Gender also had significant effects on performance measurements (see Tables 14 and 15, ADG, ADFI, feed:gain ratio, and body weight).

FIG. 5 shows the effect of the inclusion of the wheat dextrin on microbial populations. Addition of the dextrin into non-medicated diets increased fecal Lactobacillus counts (4.78×10⁸ for treatment 2 vs. 3.38×10⁸ for treatment 1) and decreased fecal E. coli counts (2.98×10⁶ for treatment 1 vs. 1.98×10⁶ for treatment 2). Addition of the wheat dextrin appeared to have served as food for healthy bacteria in the gut. The increased healthy bacteria inhibited the growth of harmful pathogens and, thus, improved pig performance.

This Example demonstrates that diets including the wheat dextrin showed improved average daily gain, average daily feed intake, and feed efficiency (feed:gain ratio), with or without antibiotic, as compared to the control diet. In addition, pigs fed the diet containing the wheat dextrin additive were approximately 3.71 kg (8.1 lbs) heavier at the end of the study than pigs fed the control diet. Animal performance, in general, also saw greater improvement for diets including the wheat dextrin than for the diet containing the antibiotic. The diet containing the wheat dextrin also improved gut health by increasing good bacteria and decreasing harmful pathogens. Collectively, this data indicated that dextrin can replace Tylan® in grow-finish diets.

### Example 6

### Wheat Dextrin and Lactose

This Example compares the effect of the inclusion of the soluble dextrin and lactose on the performance of nursery pigs. Lactose levels were examined at two levels: normal and reduced. The effect on average daily gain (“ADG”), average daily feed intake (“ADFI”), weight increase, and feed efficiency are disclosed.

A total of 180 pigs (average initial weight: 4.83 kg/pig) were used to determine the effect of wheat dextrin and lactose levels on the performance of nursery pigs. Pigs were blocked at weaning based on initial weight to one of four dietary treatments, having nine pens per treatment and five pigs per pen. The study was a 2×2 factorial arrangement, with two levels of soluble wheat dextrin (0.0% vs. 0.2%) and two levels of lactose (normal vs. reduced). Normal lactose levels were those available from commercially available nursery starter diets, such as the Momentum® product lines (available from ADM Alliance Nutrition, Inc. of Quincy, Ill.). Reduced lactose levels were 20% lower than the normal lactose levels. The study had four stages of 6, 7, 13, and 10 days, respectively. The diets were offered in pellet form in stages 1 and 2 and in meal form in stages 3 and 4. Diet compositions are listed in Tables 16-18. The results of this study, including overall weight gain, average daily gain, average daily feed intake, and feed efficiency are listed in Table 19.

TABLE 16
Composition of Stages 1 & 2 Diets

| | Treatment | | | |
|---|---|---|---|---|
| | 1 | 2 | 3 | 4 |
| | Lactose Level | | | |
| | Normal | Normal | Reduced | Reduced |
| Ingredients, weight % | | | | |
| Grain Products | 32.99 | 32.79 | 36.09 | 35.89 |
| Plant Protein | 25.00 | 25.00 | 25.00 | 25.00 |
| Milk Ingredients | 15.81 | 15.81 | 12.53 | 12.53 |
| Grain By-Products | 10.00 | 10.00 | 10.00 | 10.00 |
| Animal Protein | 8.50 | 8.50 | 8.50 | 8.50 |
| Fat | 3.70 | 3.70 | 3.63 | 3.63 |
| Others | 4.00 | 4.00 | 4.00 | 4.00 |
| Wheat Dextrin | — | 0.20 | — | 0.20 |
| Total | 100.00 | 100.00 | 100.00 | 100.00 |
| Calculated Nutrient Analysis | | | | |
| Protein, % | 23.16 | 23.16 | 23.08 | 23.08 |
| Fat; Crude, % | 6.62 | 6.62 | 6.64 | 6.64 |
| Fiber, % | 1.93 | 1.93 | 2.00 | 2.00 |
| Dry Matter, % | 90.13 | 90.13 | 89.94 | 89.94 |
| Moisture, % | 9.87 | 9.87 | 10.06 | 10.06 |
| Calcium, % | 0.99 | 0.99 | 0.99 | 0.99 |
| Phosphorus, % | 0.75 | 0.75 | 0.75 | 0.75 |
| Lysine, % | 1.57 | 1.57 | 1.57 | 1.57 |

TABLE 17
Composition of Stage 3 Diets

| | Treatment | | | |
|---|---|---|---|---|
| | 1 | 2 | 3 | 4 |
| | Lactose Level | | | |
| | Normal | Normal | Reduced | Reduced |
| Ingredients, weight % | | | | |
| Grain Products | 48.48 | 48.28 | 50.36 | 50.16 |
| Plant Protein | 29.61 | 29.61 | 29.81 | 29.81 |
| Milk Ingredients | 9.62 | 9.62 | 7.57 | 7.57 |
| Animal Protein | 4.00 | 4.00 | 4.00 | 4.00 |
| Grain By-Products | 2.00 | 2.00 | 2.00 | 2.00 |
| Fat | 2.74 | 2.74 | 2.69 | 2.69 |
| Others | 3.55 | 3.55 | 3.57 | 3.57 |
| Wheat Dextrin | — | 0.20 | — | 0.20 |
| Total | 100.00 | 100.00 | 100.00 | 100.00 |
| Calculated Nutrient Analysis | | | | |
| Protein, % | 21.63 | 21.63 | 21.66 | 21.66 |
| Fat; Crude, % | 5.15 | 5.15 | 5.16 | 5.16 |
| Fiber, % | 2.29 | 2.29 | 2.34 | 2.34 |
| Dry Matter, % | 89.07 | 89.07 | 88.94 | 88.94 |
| Moisture, % | 10.93 | 10.93 | 11.06 | 11.06 |
| Calcium, % | 0.91 | 0.91 | 0.89 | 0.89 |
| Phosphorus, % | 0.71 | 0.71 | 0.71 | 0.71 |
| Lysine, % | 1.37 | 1.37 | 1.37 | 1.37 |

TABLE 18
Composition of Stage 4 Diets

Treatment

| | 1 & 3 | 2 & 4 |
|---|---|---|
| Ingredients, weight % | | |
| Grain Products | 52.69 | 52.49 |
| Plant Protein | 34.40 | 34.40 |
| Roughage | 2.50 | 2.50 |
| Animal Protein | 3.00 | 3.00 |
| Fat | 3.91 | 3.91 |
| Others | 3.50 | 3.50 |
| Wheat Dextrin | — | 0.20 |
| Total | 100.00 | 100.00 |
| Calculated Nutrient Analysis | | |
| Protein, % | 21.00 | 21.00 |
| Fat; Crude, % | 6.25 | 6.25 |
| Fiber, % | 3.53 | 3.53 |
| Dry Matter, % | 89.21 | 89.21 |
| Moisture, % | 10.79 | 10.79 |
| Calcium, % | 0.90 | 0.90 |
| Phosphorus, % | 0.70 | 0.70 |
| Lysine, % | 1.30 | 1.30 |

TABLE 19
Effect of Wheat Dextrin and Lactose Levels on Performance of Nursery Pigs

| | Treatment No. | | | | | | | | | | |
|---|---|---|---|---|---|---|---|---|---|---|---|
| | 1 | 2 | 3 | 4 | | | | | | | |
| | Lactose Level | | | | | | | | | | |
| | Normal | Normal | Reduced | Reduced | | | P Values | | | | P Values |
| | Wheat Dextrin, kg/tonne (lb/ton) | | | | | | | Lactose | Dextrin | Lactose × | for Pair-wise |
| | 0 (0) | 2 (4) | 0 (0) | 2 (4) | Mean | Stderr | Program | Level | Level | Dextrin | Comparison¹ |
| No. pens/trt | 9 | 9 | 9 | 9 | | | | | | | |
| No. pigs/trt | 45 | 45(3)* | 45 | 45(2) | | | | | | | |
| Weight, kg | | | | | | | | | | | |
| Initial | 4.82 | 4.83 | 4.81 | 4.82 | 4.82 | 0.27 | | | | | |
| Stage 1, 6 d | 5.56 | 5.49 | 5.39 | 5.34 | 5.45 | 0.07 | 0.114 | 0.025 | 0.361 | 0.880 | bC |
| Stage 2, 7 d | 7.47 | 7.43 | 7.25 | 7.14 | 7.32 | 0.12 | 0.226 | 0.050 | 0.561 | 0.808 | c |
| Stage 3, 14 d | 14.39 | 14.70 | 14.01 | 13.91 | 14.25 | 0.20 | 0.041 | 0.008 | 0.605 | 0.323 | cDE |
| Stage 4, 8 d | 19.45 | 20.03 | 18.91 | 18.89 | 19.32 | 0.28 | 0.020 | 0.005 | 0.313 | 0.281 | DE |
| Daily gain. ka | | | | | | | | | | | |
| Stage 1, 6 d | 0.123 | 0.110 | 0.096 | 0.086 | 0.104 | 0.010 | 0.090 | 0.022 | 0.272 | 0.886 | bC |
| Stage 2, 7 d | 0.274 | 0.278 | 0.265 | 0.258 | 0.268 | 0.011 | 0.596 | 0.214 | 0.878 | 0.608 | |
| Stage 3, 14 d | 0.494 | 0.519 | 0.483 | 0.483 | 0.495 | 0.010 | 0.064 | 0.031 | 0.224 | 0.236 | aDE |
| Stage 4, 8 d | 0.632 | 0.667 | 0.612 | 0.622 | 0.633 | 0.017 | 0.170 | 0.078 | 0.219 | 0.491 | e |
| Overall, S1-2 | 0.204 | 0.200 | 0.187 | 0.179 | 0.193 | 0.009 | 0.200 | 0.045 | 0.499 | 0.791 | ce |
| Overall, S1-3 | 0.354 | 0.366 | 0.341 | 0.337 | 0.349 | 0.008 | 0.046 | 0.009 | 0.634 | 0.324 | cDE |
| Overall, S1-4 | 0.418 | 0.434 | 0.403 | 0.402 | 0.414 | 0.008 | 0.031 | 0.008 | 0.349 | 0.302 | DE |
| Feed Intake. kg/d | | | | | | | | | | | |
| Stage 1, 6 d | 0.142 | 0.130 | 0.119 | 0.111 | 0.126 | 0.009 | 0.101 | 0.028 | 0.250 | 0.812 | bC |
| Stage 2, 7 d | 0.342 | 0.339 | 0.327 | 0.309 | 0.329 | 0.011 | 0.153 | 0.049 | 0.326 | 0.494 | Ce |
| Stage 3, 14 d | 0.694 | 0.706 | 0.664 | 0.658 | 0.681 | 0.014 | 0.054 | 0.008 | 0.842 | 0.513 | cDE |
| Stage 4, 8 d | 0.895 | 0.899 | 0.874 | 0.863 | 0.883 | 0.018 | 0.447 | 0.123 | 0.856 | 0.689 | |
| Overall, S1-2 | 0.250 | 0.241 | 0.231 | 0.216 | 0.235 | 0.009 | 0.062 | 0.020 | 0.169 | 0.726 | Ce |
| Overall, S1-3 | 0.481 | 0.478 | 0.456 | 0.441 | 0.464 | 0.011 | 0.063 | 0.012 | 0.456 | 0.594 | CE |
| Overall, S1-4 | 0.575 | 0.572 | 0.551 | 0.536 | 0.559 | 0.012 | 0.098 | 0.020 | 0.442 | 0.634 | CE |
| Feed/gain | | | | | | | | | | | |
| Stage 1, 6 d | 1.177 | 1.200 | 1.383 | 1.357 | 1.279 | 0.103 | 0.388 | 0.091 | 0.991 | 0.811 | |
| Stage 2, 7 d | 1.255 | 1.242 | 1.239 | 1.235 | 1.243 | 0.023 | 0.934 | 0.627 | 0.716 | 0.830 | |
| Stage 3, 14 d | 1.405 | 1.374 | 1.378 | 1.374 | 1.383 | 0.016 | 0.456 | 0.413 | 0.268 | 0.406 | |
| Stage 4, 8 d | 1.417 | 1.387 | 1.429 | 1.391 | 1.406 | 0.019 | 0.363 | 0.672 | 0.090 | 0.831 | |
| Overall, S1-2 | 1.228 | 1.228 | 1.244 | 1.251 | 1.237 | 0.027 | 0.909 | 0.483 | 0.894 | 0.901 | |
| Overall, S1-3 | 1.355 | 1.333 | 1.342 | 1.341 | 1.343 | 0.016 | 0.807 | 0.867 | 0.474 | 0.524 | |
| Overall, S1-4 | 1.376 | 1.350 | 1.370 | 1.357 | 1.363 | 0.011 | 0.304 | 0.926 | 0.076 | 0.544 | a |

*Numbers in parentheses are numbers of pigs removed during the trial.
¹A lower case letter refers to .05 < P < .10 and an upper case letter refers to P < .05.
A or a = Trt 1 vs. Trt 2
B or b = Trt 1 vs. Trt 3
C or c = Trt 1 vs. Trt 4
D or d = Trt 2 vs. Trt 3
E or e = Trt 2 vs. Trt 4
F or f = Trt 3 vs. Trt 4

Factorial analysis found that no interactions between dietary lactose and dextrin were observed for all response variables measured in this study, suggesting that dietary lactose level does not affect the response of pigs to dietary dextrin addition, although the presence of the soluble dextrin and lactose may have positive effects on Lactobacillus growth in large intestine. For instance, the wheat dextrin improved the feed efficiency in stage 4 and cumulative stages 1 to 4 (P<0.10). Furthermore, pair-wise comparisons demonstrated that wheat dextrin addition improved overall feed efficiency (P<0.10) and increased daily gain in stage 3 (P<0.10) in diets with normal lactose levels.

Data from this study indicated that 1) reducing lactose levels of current nursery products decreased daily gain and feed intake; pigs fed the reduced lactose diets weighed approximately 0.84 kg less than pigs fed normal lactose diets; 2) lactose and wheat dextrin had no apparent interaction, indicating animal responses to them may not be affected by the presence of both ingredients; and 3) wheat dextrin addition improved overall feed efficiency, which resulted from numerical improvement of daily gain and numerical reduction of feed intake.

### Example 7

### Fermentation Biomass or Microbials+Wheat Dextrin

Mannanoligosaccharide products, such as, fermentation byproducts (biomass), for example, CitriStim™ (a trademark of Archer-Daniels-Midland Company, Decatur, Ill.) may be used in conjunction with the soluble dextrin product in an animal feed product. The resulting feed composition comprising the biomass, including mannanoligosaccharides, and soluble dextrin may show synergistic effects on gut microbial populations, immune functions, and/or growth performance. Example formulations for nursery pigs are listed in Table 20 to show how the biomass, including mannanoligosaccharides, and soluble dextrins can be used together. In addition, direct fed microbials, such as, Bacillus, can also be used in combination with the soluble dextrin product in an animal feed product. The resulting feed composition comprising the microbials and the soluble dextrin may show positive effects on gut microbial populations, immune functions, and/or growth performance.

TABLE 20
Nursery Swine Complete Feed Compositions Comprising
CitriStim ™ and Soluble Dextrin

| Ingredients, weight % | Feed I | Feed II | Feed III | Feed IV |
|---|---|---|---|---|
| Grain Products | 25.16 | 32.73 | 48.26 | 54.47 |
| Plant Protein | 20.30 | 25.00 | 29.72 | 31.17 |
| Animal Protein | 38.98 | 24.31 | 11.12 | 4.68 |
| Grain By-Products | 5.00 | 10.00 | 2.00 | 2.00 |
| Fat | 2.60 | 3.38 | 2.61 | 3.79 |
| Others | 7.46 | 4.08 | 5.79 | 3.39 |
| CitriStim ™ | 0.20 | 0.20 | 0.20 | 0.20 |
| Wheat Dextrin | 0.30 | 0.30 | 0.30 | 0.30 |
| Total | 100.00 | 100.00 | 100.00 | 100.00 |
| Protein, % | 24.76 | 23.58 | 21.98 | 20.97 |
| Fat, % | 5.61 | 6.74 | 5.24 | 6.24 |
| Dry Matter, % | 90.74 | 89.96 | 88.81 | 88.00 |
| Moisture, % | 9.26 | 10.04 | 11.19 | 12.00 |
| Calcium, % | 0.98 | 1.00 | 0.90 | 0.90 |
| Phosphorus, % | 0.85 | 0.75 | 0.70 | 0.70 |
| Lysine, % | 1.75 | 1.50 | 1.35 | 1.25 |

Although the foregoing description has disclosed a number of exemplary embodiments, those of ordinary skill in the relevant art will appreciate that various changes in the components, compositions, details, materials, and process parameters of the examples may be made by those of ordinary skill in the art, and all such modifications remain within the principle and scope of the invention as disclosed herein and in the appended claims. It will also be appreciated by those of ordinary skill in the art that modifications or combinations may be made to the embodiments described herein without departing from the broad inventive concept thereof. It is understood, therefore, that this invention is not limited by the exemplary embodiments, but includes modifications that are within the principle and scope of the invention, as defined by the claims.

We claim:

1. A method of feeding an animal comprising:
obtaining a soluble dextrin product comprising at least 40% soluble fiber and having an average molecular weight of approximately 2500 atomic mass units;
mixing the soluble dextrin product with at least one feed ingredient, thus producing an animal feed composition; and
feeding the animal feed composition to the animal.

2. The method according to claim 1, wherein the soluble dextrin product comprises from 10% to 20% of oligosaccharides having from 2 to 10 degrees of polymerization.

3. The method according to claim 1, wherein a substantial portion of the soluble dextrin product passes through an upper gastrointestinal tract of the animal and into a large intestine of the animal, such that the soluble dextrin product serves as a food source for beneficial bacteria in the large intestine.

4. The method according to claim 3, wherein the beneficial bacteria comprise at least one of Lactobacillus and Bifidobacteria.

5. The method according to claim 3, wherein a population of harmful bacteria comprising at least one of Escherichia coli, Salmonella, and Clostridium is decreased in a digestive tract of the animal.

6. The method according to claim 1, wherein the animal feed composition is in dry or liquid form and the soluble dextrin product comprises 0.1% to 2.0% of the animal feed composition.

7. The method according to claim 1, wherein mixing the soluble dextrin product with at least one feed ingredient comprises mixing a concentrate of the soluble dextrin product having from 0.28% to 10% of the soluble dextrin product with the at least one feed ingredient such that the animal is fed 10% to 35% of the concentrate.

8. The method according to claim 1, wherein mixing the soluble dextrin product with at least one feed ingredient comprises mixing a pre-mix having from 2% to 50% of the soluble dextrin product such that the animal is fed 2% to 5% of the pre-mix.

9. The method according to claim 1, wherein feeding the animal feed composition to the animal comprises placing the animal feed composition on feed matter as a top-dress.

10. The method according to claim 1, further comprising mixing a second feed ingredient selected from the group consisting of a mannanoligosaccharide product, a direct fed microbial product, a beta-glucan product, an amino acid, a sugar alcohol, a sugar, a milk product, a vitamin, a mineral, and any combinations thereof with the soluble dextrin product.

11. The method according to claim 1, wherein the animal is selected from the group consisting of bovines, ovines, swine, equines, ratites, poultry, fowl, canines, felines, fish and crustaceans.

12. The method according to claim 1, wherein the animal feed composition is capable of improving at least one of growth performance, feed efficiency, disease resistance, general health, and lactation performance of the animal, as compared to an animal fed a comparable animal feed composition without the soluble dextrin product.

13. An animal feed composition comprising:
at least one feed ingredient; and
a soluble dextrin having at least 40% soluble fiber.

14. The animal feed composition of claim 13, wherein the soluble dextrin is of a wheat origin.

15. The animal feed composition of claim 13, where the soluble dextrin has a dextrose equivalent of 1 to 20

16. The animal feed composition of claim 13, wherein the soluble dextrin has an average molecular weight of approximately 2500 amu.

17. The animal feed composition of claim 13, wherein 15% of the oligosaccharides of the soluble dextrin have a degree of polymerization from 2 to 10.

18. The animal feed composition of claim 13, wherein the soluble dextrin is present at 0.1% to 2.0% by weight of the animal feed composition.

19. The animal feed composition of claim 13, wherein the animal feed composition increases a population of beneficial bacteria selected from the group consisting of Lactobaccilus, Bifidobacteria and combinations thereof in a gastrointestinal tract of an animal upon feeding of the animal feed composition to the animal.

20. The animal feed composition of claim 13, wherein the animal feed composition decreases the growth of harmful bacteria selected from the group consisting of Escherichia coli, Clostridia, Salmonella and combinations of any thereof in a gastrointestinal tract of an animal upon feeding the animal feed composition to the animal.

21. The animal feed composition of claim 13, wherein the animal feed composition is capable of decreasing at least one of odor related compounds, odor emission, and the offensiveness to human and animals, of manure of the animals to which the animal feed composition is fed

22. The animal feed composition of claim 13, wherein the at least one feed ingredient is selected from the group consisting of a mannanoligosaccharide product, a direct fed microbial product, a beta-glucan product, an amino acid, a sugar alcohol, a sugar, a milk product, a vitamin, a mineral, and combinations of any thereof.

23. The animal feed composition of claim 13, wherein the animal feed composition is configured as a liquid or dry form and further comprises an amino acid selected from the group consisting of lysine, methionine, threonine, and combinations of any thereof.

24. A container comprising:
the animal feed composition of claim 13, having the soluble dextrin present in at least 2% by weight of the animal feed composition; and
indicia associated with the container, wherein the indicia is configured to direct a user of the animal feed composition on how to mix the animal feed composition with another feed ingredient, how to feed the animal feed composition to an animal or a combination thereof.

25. A method of distributing an animal feed comprising:
admixing a soluble dextrin product with at least one feed ingredient selected from the group consisting of a mannanoligosaccharide product, a direct fed microbial product, a beta-glucan product, an amino acid, a sugar alcohol, a sugar, a milk product, a vitamin, and combinations of any thereof, thus producing the animal feed composition;
placing the animal feed composition in a container configured for shipping; and
transporting the container to a location.

26. The method according to claim 25, further comprising associating indicia with the container, wherein the indicia is configured to direct a user of the animal feed composition on how to mix the animal feed composition with another feed ingredient, how to feed the animal feed composition to the animals, or a combination thereof.

27. The method according to claim 25, further comprising feeding the animal feed composition to the animals.

28. The method according to claim 25, wherein the soluble dextrin product is of a wheat origin.

29. The method according to claim 25, further comprising obtaining the soluble dextrin by a process comprising:
placing an unmodified starch at an acidic pH;
heating the unmodified starch at the acidic pH to a temperature such that chemical bonds of the unmodified starch are altered, wherein the altered chemical bonds are resistant to digestion in a gastrointestinal tract of an animal; and
isolating the starch with the altered chemical bonds, thus producing the soluble dextrin.
